(19) United States
(12) Patent Application Publication
(10) Pub. No.: US 2006/0160590 A1
(43) Pub. Date: Jul. 20, 2006

(54) Gaming machine

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/311,232

(22) Filed: Dec. 20, 2005

(30) Foreign Application Priority Data
Dec. 27, 2004 (JP) P2004-377787
Dec. 27, 2004 (JP) P2004-377788

(51) Int. Cl. A63F 13/00

(52) U.S. Cl. 463/1

(57) ABSTRACT

One embodiment of the present invention is a gaming machine connected to a network, and the gaming machine comprises: a detecting unit which detects a figure; a game-progressing information sending unit which sends to another device game-progressing information indicating that the gaming machine is in game-progressing based on the detection information detected by the detecting unit; a game-progressing information receiving unit which receives the game-progressing information sent from other device; and a display unit which displays an image indicating the another gaming machine being in a game-progressing mode, based on the received game-progressing information on the another gaming machine.

### CROSS REFERENCE TO RELATED APPLICATIONS

This application is based upon and claims the benefit of priority from the prior Japanese Patent Applications No. 2004-377787, filed on Dec. 27, 2004 and No. 2004-377788, filed on Dec. 27, 2004 the entire contents of which are incorporated herein by reference.

### BACKGROUND OF THE INVENTION

1. Field of the Invention

The present invention relates to gaming machines, and in particular, relates to gaming machines connected and communicated with one another.

2. Description of the Related Art

Conventionally, it has been well known that a plurality of gaming machines are connected and communicated with one another, and several games, including a special game such as a bonus game, is ran on between these gaming machines. For example, in the case where the gaming machines is configured to execute so called a Jackpot (that means a kind of a bonus game or a common bonus), a large number of coins are accumulated as the Jackpot by each of the gaming machines, thereby enabling setting of a premium which is greater than a premium being obtained by a winning-combination set by one gaming machine, and a large accumulated bonus is paid-out to a winner who has win a lottery for the Jackpot, thereby raising the gaming feeling of players.

With playing the Jackpot ran on a gaming system which is comprised of a plurality of gaming machines communicably connected to each other, in order for a player to efficiently gain a winning-combination with a large premium (the Jackpot), for example, it is important to know whether or not the other players (competitor's) are currently playing with the another gaming machines connected to the gaming system, respectively. In the gaming system, the competitors also attempt to gain the Jackpot. Accordingly, if a number of the competitors are small, a rate of gaining the Jackpot increases. In contrast, if a number of the competitors are large, a rate of gaining the Jackpot decreases.

In addition, information regarding an ID of the another gaming machine, and/or information regarding the competitor's technique is also effective in gaining the Jackpot.

Although a plurality of the gaming machines can be disposed in a variety of patterns, in general, the player plays a game at a position facing to a display device of own gaming machine. Thus, in order to check whether or not the competitor is present, it is indispensable to check whether or not the competitor is currently playing the same game with the another gaming machine while turning the player's eye from the display device of the gaming machine. Accordingly, if the player plays a game while always paying attention to check whether or not the competitor is present, such player cannot concentrate his or her attention on the game.

In addition, in order to know a point acquired by another gaming machines, accumulated points, or a game state such as a game result, a displayed image of the another gaming machine must be observed. However, it is eventually impossible to observe the displayed image of such the another gaming machine while playing the game.

Therefore, it is a first object of the present invention to solve the above-described problem and to provide a gaming machine capable of checking the presence or absence of a competitor who plays with an another gaming machine while playing a game with the player's gaming machine.

Further, it is a second object of the present invention to solve the above-described problem and to provide a gaming machine capable of checking a game state of a competitor while playing a game whit the player's gaming machine.

### SUMMARY OF THE INVENTION

In order to achieve the first object, a gaming machine according to the present invention is directed to a gaming machine connected to a network, the gaming machine comprising: a detecting unit which detects a figure indicating a player of the gaming machine; game-progressing information sending unit for sending to a device (such as an another gaming machine, a server), game-progressing information indicating that the gaming machine is in a game-progressing mode based on detection information detected by the detecting unit; game-progressing information receiving unit which receives game-progressing information sent from the device connected to a network; and a display unit which displays an image indicating the another gaming machine that is in the game-progressing mode based on received game-progressing information of the another gaming machine.

In such a configuration, the figure is used as an indicator for indicating that the player is in the game-progressing mode. This figure is composed of: a doll obtained by three-dimensionally abstracting a character displayed on a screen of the gaming machine or a card being printed with the character thereon, for example. The game-progressing mode is displayed by displaying an image of the character specified by this figure.

The detecting unit is a unit which detects the figure of the gaming machine. In the case where the figure is the doll or the card and the like, the detecting unit detects the doll or the card placed at a predetermined position of the gaming machine. In the case where the figure or the card is not the figure, the detecting unit is configured to render the player to select the figure by a selecting operation such as operating a selecting button or the like which the gaming machine has. The detecting unit outputs a detected figure as detection information; specifies the figure which a player uses from this detection information; and generates game-progressing information indicating that the gaming machine is in the game-progressing mode.

The game-progressing information used here is an indicator which indicates that the gaming machine is in the game-progressing mode. It is possible to check that the gaming machine is in the game-progressing mode by displaying on the gaming machine an image such as the character relating to the figure thereof based on the game-progressing information.

Further, the game-progressing information can be handled as figure-identification data (figure identification code) for specifying a detected figure, for example, and it is recognized that the gaming machine is in the game-progressing mode by sending the figure-identification data.

The figure-identification data used here is identification data for specifying the figure for a player. This data can be stored in a recording medium such as an IC tag or coded such as a two-dimensional code, and this recording medium or two-dimensional code can be mounted on a surface or inside of the figure. The gaming machine having the figure placed thereon can detect the figure-identification data by the detecting unit.

The detecting unit which detects figure-identification data is configured to detect a case in which the recording medium is an IC tag in a wireless (non-contact) manner, and can optically detect a case in which the figure-identification data is coded in a two-dimensional code. In addition, the selecting button provided with the gaming machine can be used as the detecting unit.

According to the present invention, an image such as the character of the figure placed on another gaming machine is displayed on the gaming machine (player's gaming machine), thereby making it possible to check the presence or absence of another player playing the game simultaneously (first display mode).

In addition, according to the present invention, an image such as the character of the figure placed on player's gaming machine is displayed on his/her gaming machine, and the image is enhanced according to a game state, thereby making it possible to enhance gaming property (second display mode).

In the present invention, the game-progressing information sending unit is a sending unit which sends to another device (such as another gaming machines and a server), the game-progressing information indicating that the gaming machine is in the game-progressing mode based on the detection information detected by the detecting unit. In addition, the game-progressing information receiving unit is a receiving unit which receives the game-progressing information sent from the another device connected to a network. As the game-progressing information to be sent and received, for example, the figure-identification data can be used.

In the present invention, the display unit is configured to display image indicating the another gaming machine that is in the game-progressing mode based on received game-progressing information of the another gaming machine. This makes it possible for the player to check the presence and absence of the competitor.

In the case where the figure-identification data is used as the game-progressing information, image data for displaying the figure as an image based on this figure-identification data is read out from a storing unit, and display image data is generated by using the read out image data. The image data used to form display image data is stored in the storing unit provided in the gaming machine or in the server, and the figure-identification data is read out as a read out key.

Here, another device receiving the game-progressing information includes the another gaming machine or the server connected to a network. The gaming machine receives the game-progressing information directly from the another gaming machine and receives the game-progressing information from the another gaming machine via the server.

The image display unit displays a game state of the gaming machine and displays an image indicating the another gaming machine that is in the game-progressing mode. As an image indicating the another gaming machine is in the game-progressing mode, it is possible to display an image such as the character of the figure detected by the another gaming machine, and the player can check competitor's playing the same game by seeing the character image of the figure displayed on the display screen of the player's gaming machine. At this time, the player can speculate the competitor by seeing the competitor's figure.

In the gaming machine, a plurality of the figures or items can be placed on a placement base of the gaming machine. The detecting unit according to the present invention simultaneously or individually detects a plurality of the figures placed on the placement base of the gaming machine, and reads out image data which corresponds to the figure from among image data which the gaming machine or the server has, based on the detected detection information. The display unit is configured to generate display image data by using the read out image data and can display a plurality of the figures placed on the placement base.

In addition, the image data comprises a plurality of shape data for defining the shape of the figure and a plurality of display state data for defining a display state of each section of the figure, respectively. The image display unit captures a game state of the gaming machine; reads out plural types of the shape data and/or display state data according to the game state; and generates display image data by using the read out image data. In this manner, the figure according to the game state can be displayed.

The above-described game state is the number of points acquired in gaming, and the shape data and display state data are stored to be associated with the number of points. The image display unit reads out the shape data and/or display state data according to the number of points in gaming, and display image data is generated by using the read out image data. In this manner, the figure according to the number of points is displayed as the game state.

Further, in order to achieve the above-described second object, a gaming machine according to the present invention is directed to a gaming machine connected to a network, the gaming machine comprising: a detecting unit which detects a figure; game-progressing information sending unit which sends to another device (an another gaming machine, a server), game-progressing information indicating that the gaming machine is in a game-progressing mode based on detection information from the detecting unit; a game-progressing information receiving unit which receives the game-progressing information sent from another device connected to a network; a game information sending unit which sends the game information indicating a game state of the gaming machine to another device; game information receiving unit which receives the game information indicating a game state of the another gaming machine, the game state being sent from another device; and a display unit which displays an image indicating that the another gaming machine that is in the game-progressing mode based on received game-progressing information of the another gaming machine and changes an image indicating the game state of the another gaming machine or the fact that the another gaming machine that is in the game-progressing mode, based on received game information of the another gaming machine.

In addition, in the present embodiment, the game information indicates the game state of the gaming machine, and can include accumulated points maintained by the gaming machine, an acquisition point which the gaming machine acquires for each game, and a result of each game in the gaming machine.

In addition, the image display unit displays the game state of at least one of the accumulated points of the another gaming machine, an acquisition point of each game, and a result of each game, and changes an image indicating that the another gaming machine is in the game-progressing mode based on these items of the game information. A player can know the game state of the another gaming machine by accumulated points of the another gaming machine displayed on the image display unit, an acquisition point of each game, a result of each game, or a change of an image indicating that the gaming machine is in the game-progressing mode.

In addition, in the case where figure-identification data is used as game-progressing information, image data for displaying the figure as an image based on this figure-identification data is read out from a storing unit, and display image data is generated by using the read out image data. The image data used to form the display image data is stored in the storing unit provided in the gaming machine or in the server, and the figure-identification data is read out as a read out key.

### BRIEF DESCRIPTION OF THE DRAWINGS

FIG. 1 is a schematic view to explain a first embodiment of a gaming machine according to the present invention;

FIG. 2 is a flow chart to explain the first embodiment of the gaming machine according to the present invention;

FIG. 3 is a schematic view to explain a second embodiment of a gaming machine according to the present invention;

FIG. 4 is a flow chart to explain the second embodiment of the gaming machine according to the present invention;

FIG. 5 is a schematic view to explain a third embodiment of a gaming machine according to the present invention;

FIG. 6 is a flow chart to explain the third embodiment of the gaming machine according to the present invention;

FIG. 7 is an external view showing an example of a configuration of a gaming machine according to the present invention;

FIG. 8 is a block diagram to explain an example of an internal configuration of a gaming machine according to the present invention;

FIG. 9 shows an example of a display image in player's gaming machine according to the present invention;

FIG. 10 shows an example of a display image in player's gaming machine according to the present invention;

FIG. 11 shows an example of a display image in another gaming machine according to the present invention;

FIG. 12 shows an example of a display image in another gaming machine according to the present invention;

FIG. 13 shows an example of a display image according to a third selection of a gaming machine of the present invention;

FIG. 14 shows another example of a display image according to a third selection of a gaming machine of the present invention;

FIG. 15 shows an example of a display image for displaying an item together with a figure according to a gaming machine of the present invention;

FIG. 16 shows an example of a display image for changing a display image depending on a game state of a gaming machine according to the present invention;

FIG. 17 is a view to explain an example of disposing a plurality of gaming machines according to the present invention;

FIG. 18 is a view to explain an example of disposing a plurality of gaming machines according to the present invention;

FIG. 19 is a view to explain an example of disposing a plurality of gaming machines according to the present invention;

FIG. 20 is a view to explain a data structure for displaying a character image or an item image of a figure of a gaming machine according to the present invention;

FIG. 21 is a schematic view to explain a fourth embodiment of a gaming machine according to the present invention;

FIG. 22 is a flow chart to explain the fourth embodiment of the gaming machine according to the present invention;

FIG. 23 is a schematic view to explain a fifth embodiment of a gaming machine according to the present invention;

FIG. 24 is a flow chart to explain the fifth embodiment of the gaming machine according to the present invention;

FIG. 25 is a schematic view to explain a sixth embodiment of a gaming machine according to the present invention;

FIG. 26 is a flow chart to explain the sixth embodiment of a gaming machine according to the present invention;

FIG. 27 is a block diagram depicting an example of internal configuration of a gaming machine according to the present invention;

FIG. 28 shows an example of a display image in player's gaming machine according to the present invention;

FIG. 29 shows an example of a display image in player's gaming machine according to the present invention;

FIG. 30 shows an example of a display image in another gaming machine according to the present invention; and

FIG. 31 shows an example of a display image for changing a display image according to a game state in player's gaming machine according to the present invention.

### DETAILED DESCRIPTION OF THE INVENTION

Hereinafter, preferred embodiments of the present invention will be described in detail with reference to the accompanying drawings.

First, a description will be given with respect to a configuration of first to third embodiments of a gaming machine according to the present invention. In any of the first to third embodiments, figure-identification data for identifying a figure is acquired, and this figure-identification data is sent to the another gaming machine as game-progressing information. In the case where game-progressing information has been received from a gaming machine in game-progressing, a character or the like of a figure is displayed on a display unit based on the received game-progressing information, and the fact that a gaming machine in game-progressing exists is displayed.

The first and second embodiments are configured to detect a figure placed on a gaming machine, wherein the first embodiment is an embodiment in which image data for displaying a character or the like of a figure as an image is stored in each gaming machine, and the second embodiment is an embodiment in which image data is stored in a server.

In addition, the third embodiment is configured to show a figure, which displayed on a display unit, by selecting buttons or the like.

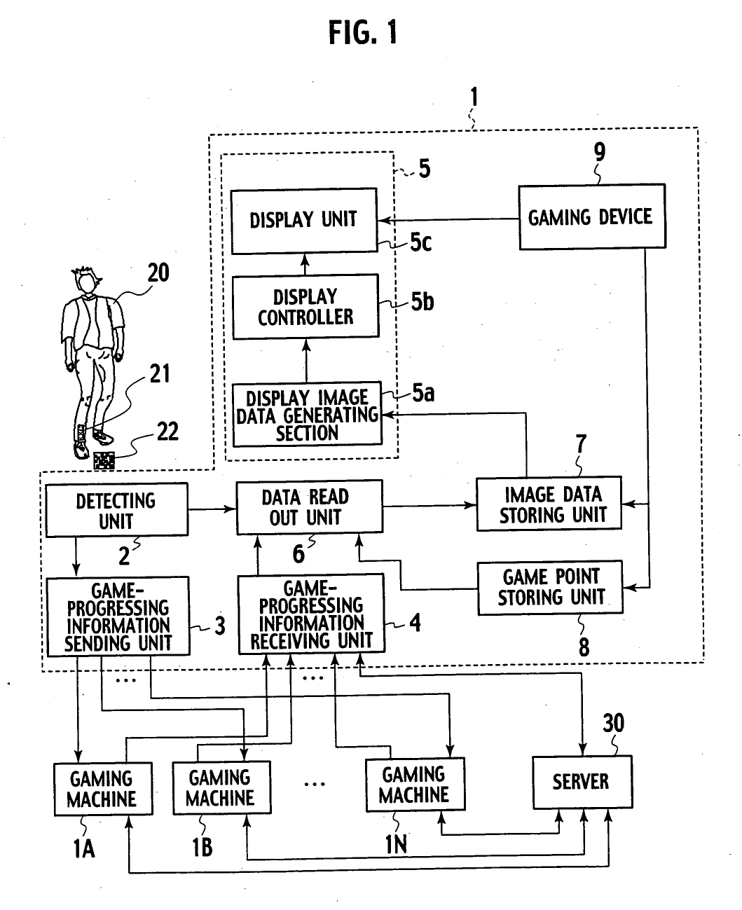

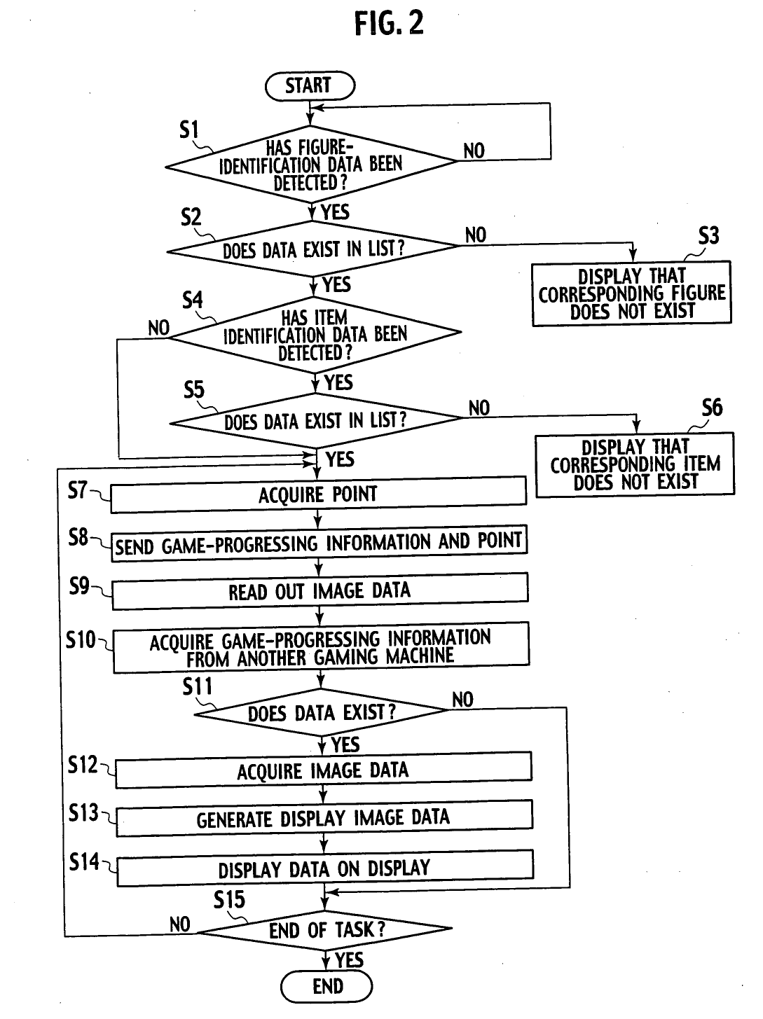

FIG. 1 is a schematic view showing the first embodiment, and FIG. 2 is a flow chart showing the first embodiment.

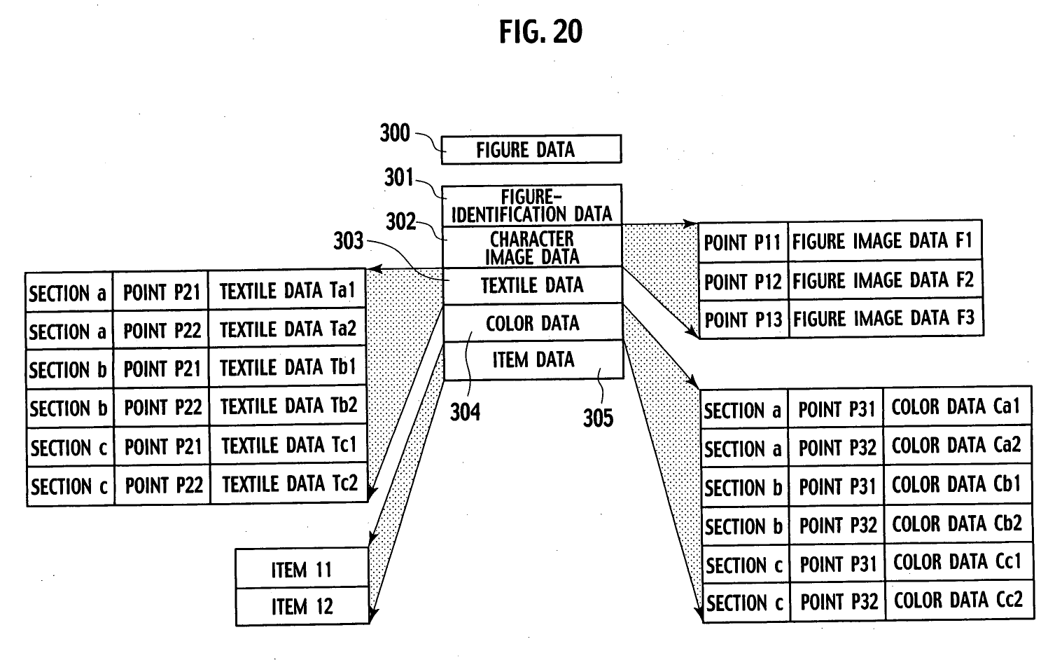

A gaming machine 1 includes constituent elements for displaying the another gaming machine that is in the game-progressing mode exists in addition to a gaming device 9 which carrying out a variety of gaming operations. This gaming machine 1 comprises a detecting unit 2 which detects a FIG. 20, a game-progressing information sending unit 3 which sends game-progressing information such as figure-identification data detected by the detecting unit 2 to another device (other gaming machines 1A, 1B, . . . , 1N, or server 30), game-progressing information receiving unit 4 which receives game-progressing information sent from another device, a figure-data read out unit 6 which reads out detection information detected by the detecting unit 2 and/or figure-identification data from game-progressing information received by the game-progressing information receiving unit 4, an image-data storing unit 7 which stores image data such as a character of a figure, a display means 5 which displays an image by using the image data read out from the image-data storing unit 7 based on the figure-identification data, and a game-point storing unit 8 which stores game points such as obtained bonus acquired by the gaming device 9.

The display means 5 further comprises a display image data generating section 5a which generates display image data by using the image data or game points read out from the image-data storing unit 7, a display unit 5c which displays display image data, and a display controller 5b which controls the display unit 5c to display the display image data. The display unit 5c can also function as a display unit of the game device 9.

A FIG. 20 has a recording medium such as an IC tag 21 or a two-dimensional code 22 at a bottom part, a side part, or an inside of a figure main body. The recording medium stores figure-identification data (figure identification code) for identifying the FIG. 20. A player plays a game while player's FIG. 20 is placed on a placement base (not shown) of the gaming machine 1.

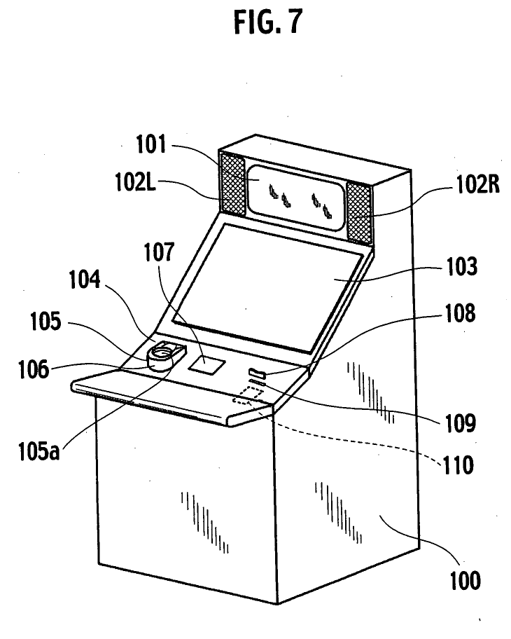

The detecting unit 2 detects the FIG. 20 placed on a placement base 105 (see FIG. 7). The detecting unit 2 reads out figure-identification data recorded in a recording medium such as an IC tag 21 or a two-dimensional code 22 and the like in which the figure-identification data 20 has been provided. In the case where the detecting unit 2 reads out figure-identification data from the IC tag 21, the detecting unit 2 carries out detection in a non-contact manner by wireless communication using an IC tag reader (not shown). Alternatively, in the case where figure-identification data is read out from the two-dimensional code 22, detection is optically carried out by using an optical scanner (not shown).

A recording medium can be used as another configuration without being limited to the above-described IC tag 21 or two-dimensional code 22. At this time the detecting unit 2 is used as a constituent element according to the recording medium.

The game-progressing information sending unit 3 receives the figure-identification data detected by the detecting unit 2, and sends this figure-identification data as game-progressing information to another device (such as another gaming machines 1A to 1N or server 30) via a network (not shown).

The another gaming machines 1A to 1N receive game-progressing information (figure-identification data) sent from the game-progressing information sending unit 3. In addition, the server 30 receives the game-progressing information sent from the game-progressing information sending unit 3, and sends the received game-progressing information to the gaming machines 1A to 1N connected to a network. Such another gaming machines 1A to 1N receive game-progressing information transmitted directly or via the server 30 from the gaming machine 1, thereby making it possible to display on the display unit 5c and check that a gaming machine which is a sending source of the game-progressing information is currently in the game-progressing mode.

The game-progressing information receiving unit 4 receives game-progressing information (figure-identification data) sent directly from another gaming machines 1A to 1N via a network or sent from other gaming machines 1A to 1N via the server 30.

After figure-identification data for identifying a FIG. 20 of player's gaming machine 1 is inputted from the detecting unit 2 to the data read out unit 6 and game-progressing information on other gaming machines 1A to 1N is inputted from the game-progressing receiving unit 4, the figure-identification data is read out, and image data corresponding to the read out figure-identification data is sent to the image-data storing unit 7. In the case where accumulated points such as accumulated bonus are stored in the game point storing unit 8, the accumulated points are read out from the game point storing unit 8 and are sent to the image-data storage unit 7. In addition, the acquired points acquired for each item of data can be acquired from the game device 9.

The image-data storing unit 7 outputs to the display image data generating section 5a, image data such as the character of the FIG. 20 while figure-identification data from the data read out unit 6 is defined as a search key. In addition, accumulated points or acquired points are inputted so as to output image data set by differentiating shapes, colors, or textiles and the like in advance according to the points. Accordingly, a display of the competitor's figure is changed according to accumulated points of that gaming machine 1 and acquired points of each game, or a game result, thereby making it possible to display a game state of the another gaming machines 1A to 1N and to carry out game directing for changing a display of player's figure according to player's accumulated points or acquired points of each game.

In the display means 5, the display image data generating section 5a generates display image data suitable for display on the display unit 5c using the image data inputted from the image-data storing unit 7. The display image data generating section 5a may generate display image data by combining another item of data with image data, thereby making it possible to enhance game directing property.

The display controller 5b carries out control when display image data generated by the display image data generating section 5a is displayed on the display unit 5c.

Now, an example of an operation of a configuration shown in FIG. 1 will be described with reference to a flow chart shown in FIG. 2. Here, a description will be given for an example of displaying an image with respect to an item as well as a figure.

When the FIG. 20 is placed on a placement base (not shown in FIG. 1) of the gaming machine 1, the detecting unit 2 detects figure-identification data recorded in a recording medium such as an IC tag 21 or a two-dimensional code 22 and the like provided in this FIG. 20 (step S1: hereinafter, referred to as S1).

A search is made for list data on figure-identification data, for example, in order to determine that image data corresponding to the detected figure-identification data is stored in the image-data storing unit 7 (S2). In the case where the figure-identification data is not found in the list data, it is assumed that the corresponding image data is not stored, and a notice that the corresponding figure does not exist is displayed on the display unit 5c (S3).

In addition, further detection is made for the FIG. 20, that is the presence or absence of an item is detected. The detecting unit 2 detects item-identification data recorded from a recording medium such as an IC tag 21 or a two-dimensional code 22 provided in this item (not shown) (S4). A search is made for list data on item-identification data, for example, in order to determine whether or not the image data corresponding to the detected item-identification data is stored in the image-data storing unit 7 (S5). In the case where the item-identification data is not found in the list data, it is assumed that the corresponding image data is not stored, and the fact that the corresponding item does not exist is displayed on the display unit 5c (S6).

In the case where figure-identification data and/or item-identification data have (has) been detected, acquired points of each game is acquired from the gaming device 9 and accumulated points are acquired from the game point storing unit 8 (S7).

The game-progressing information sending unit 3 sends to another device (the another gaming machines 1A to 1N or the server 30) the acquired figure-identification data or item-identification data. The data such as acquired points, accumulated points, or a game result may be sent (S8).

The image-data storing unit 7 reads out image data corresponding to the acquired figure-identification data, item-identification data, acquired points, accumulated points, and a game result or the like. The image-data storing unit 7 stores image data on a character of a figure which corresponds to figure-identification data or image data on an item which corresponds to item-identification data.

Further, in the case where an effect for changing a display state of the FIG. 20 or item is carried out according to acquired points, accumulated points, or a game result, image data corresponding to these points or game result is stored in advance, and the corresponding image data is read out while the figure-identification data, item-identification data, acquired points, accumulated points, or a game result and the like is defined as a search key. This image data relates to a figure or an item placed on player's gaming machine (S9).

The game-progressing information receiving unit 4 receives game-progressing information of the another gaming machines 1A to 1N or the server 30 (S10). In the case where figure-identification data or item-identification data is included in game-progressing information, the receiving unit 4 reads out the figure-identification data or item-identification data (S11) or reads out image data on a figure or an item relating to the another gaming machines 1A to 1N corresponding thereto from the image data-storing unit 7 (S12).

The display image-data generating section 5a generates the FIG. 20 or item of player's gaming machine 1 read out from the image-data storing unit 7 or display image data for displaying the FIG. 20 or item of the another gaming machines 1A to 1N (S13). The display unit 5c displays the generated display image data on the display unit 5c under the control of the display controller 5b (S14).

In the case where a gaming machine 1 that is in the game-progressing mode ends a game or in the case where the gaming machine 1 which has been not in the game-progressing mode starts a game midway, to change a current state to a game state, for example, the step S7 to S14 are repeated, thereby displaying a game-progressing state of changed the another gaming machines 1A to 1N (S15).

### Second Embodiment

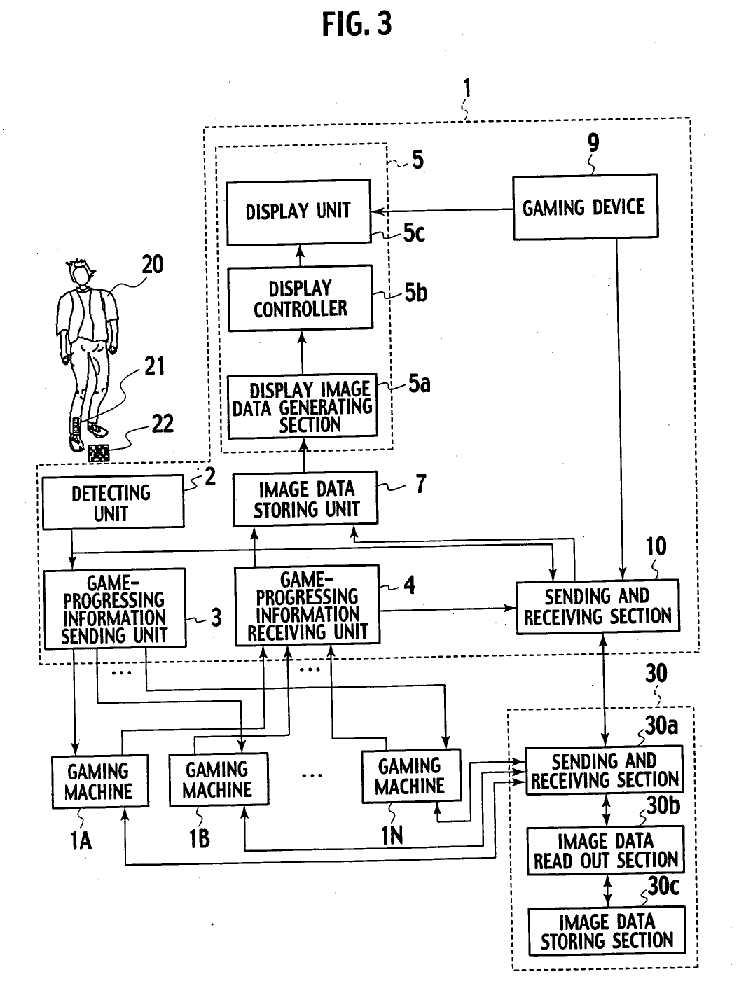

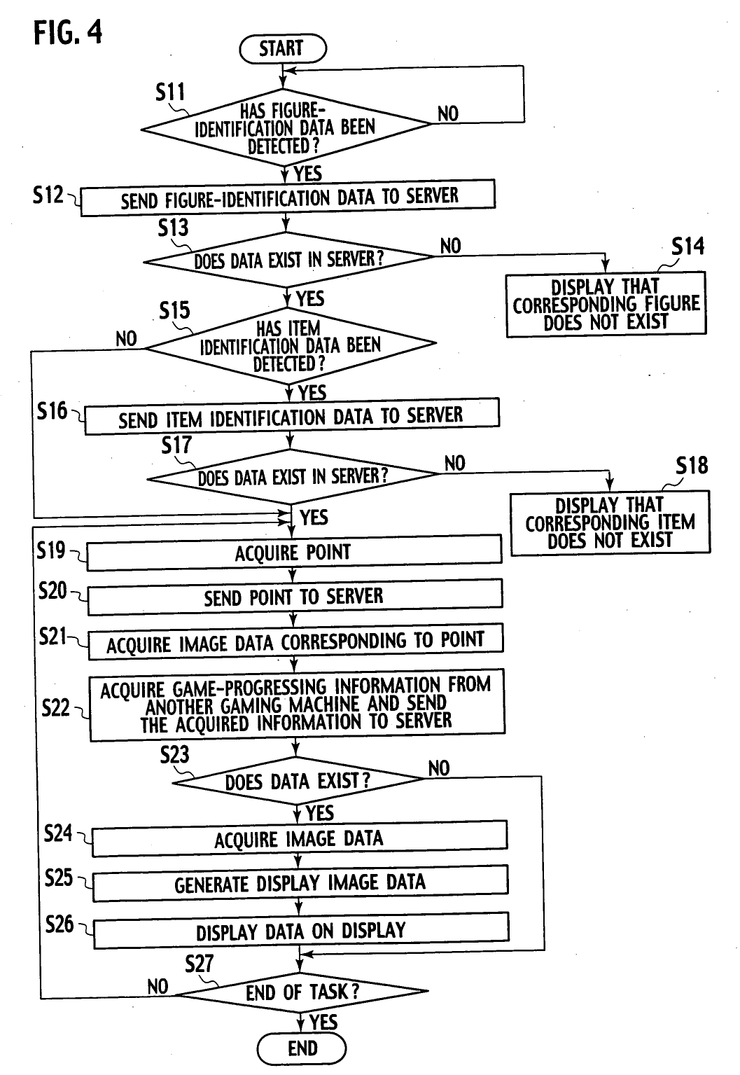

FIG. 3 is a schematic view showing a second embodiment. FIG. 4 is a flow chart showing the second embodiment. In the second embodiment, figure-identification data for identifying a FIG. 20 is acquired, and this figure-identification data is sent to the another gaming machines 1A to 1N as game-progressing information. In the case where game-progressing information has been received from a gaming machine 1 of the embodiment is in the game-progressing mode, a character or the like of the FIG. 20 is displayed on a display unit based on the received game-progressing information, and the fact that the gaming machines 1 (1A to 1N) which is in the game-progressing mode exists is displayed.

Now, detailed description of the second embodiment will be described below.

The second embodiment is substantially identical to the first embodiment except that a server 30 stores image data for displaying a character of a figure as an image. In the following, a description will be given with respect to constituent elements which are different from those according to the first embodiment. Common constituent elements will be briefly described.

A gaming machine 1, as in the first embodiment, includes constituent elements for displaying that other gaming machines 1A to 1N that is in the game-progressing mode exists in addition to the game device 9 which carries out a variety of gaming operations. This gaming machine 1 comprises a detecting unit 2 which detects a FIG. 20, a game-progressing information sending unit 3 which sends to other gaming machines 1A to 1N the game-progressing information detected by the detecting unit 2, a game-progressing information receiving unit 4 which receives game-progressing information sent from the another gaming machines 1A to 1N, a sending and receiving section 10 which carries out sending and receiving with a server 30, an image-data storing unit 7 which stores image data such as a character of the FIG. 20 received from the server 30 by means of sending and receiving section 10, and a display means 5 which carries out image display by using image data read out from the image-data storing unit 7.

The sending and receiving section 10 sends detection information detected by the detecting unit 2 to the server 30 as game-progressing information. In addition, the sending and receiving section 10 sends the game-progressing information received by the game-progressing information receiving unit 4 to the server 30 and the acquired points from the gaming device 9, and receives image data read out at the server side based on the sent data, from the server 30.

The server 30 comprises a sending and receiving section 30a, a data read out unit 30b, and an image-data storing section 30c. The data read out unit 30b reads out figure-identification data or acquired points from game-progressing information sent from the gaming machine 1 (or from the another gaming machines 1A to 1N), and reads out image data from the image-data storing section 30c based on the read out figure-identification data or acquired points.

According to the second embodiment, image data is stored in the server 30, and thus, there is no need for each gaming machine to store image data according to figure-identification data or the like, respectively, and image data maintenance or updating can be easily carried out.

The display means 5, as in the first embodiment, comprises a display image data generating section 5a, a display controller 5b, and a display unit 5c. The detecting unit 2 detects a FIG. 20 placed on a placement base 105 (see FIG. 7).

The game-progressing information sending unit 3 sends to the another gaming machines (another gaming machines) 1A to 1N via a network (not shown) figure-identification data detected by the detecting unit 2 as game-progressing information. The another gaming machines 1A to 1N receive the game-progressing information (figure-identification data) sent from the game-progressing information sending unit 3.

In addition, the server 30 receives at the sending and receiving section 30a the game-progressing information sent from the game-progressing information sending unit 3. The image data read out section 30b reads out image data of the FIG. 20 from the image-data storing section 30c based on the received game-progressing information (figure-identification data), and sends the read out data to the sending and receiving section 10 of the gaming machine 1.

The sending and receiving section 10 of the gaming machine 1 receives image data sent from the server 30, stores the received data in the image-data storing unit 7, and displays the stored data on the display unit 5c.

The game-progressing information receiving unit 4 receives game-progressing information (figure-identification data) sent from the another gaming machines 1A to 1N via the network. The game-progressing information of the another gaming machines 1A to 1N are sent from the sending and receiving section 10 to the server 30, and image data of the FIG. 20 relating to the another gaming machines 1A to 1N is acquired from the server 30.

As shown in FIG. 1, in the first embodiment, the game point storing unit 8 stores image data of the FIG. 20 which has different shapes, colors, or textiles and the like according to player's accumulated points or acquired points of each game, and reads out the corresponding image data depending on the accumulated points or acquired points. However, in the second embodiment, this function is configured to execute in the server 30, whereby a game effect for making a change according to points can be carried out.

In the display means 5, the display image data generating section 5a generates display image data suitable for display on the display unit 5c by using the image data inputted from the image-data storing unit 7. The display image data generating section 5a generates display image data by combining another item of data with image data, whereby a game effect property may be enhanced.

The display controller 5b carries out control when the display image data generated by the display image data generating section 5a is displayed on the display unit 5c.

Now, an example of an operation of a configuration shown in FIG. 3 will be described with reference to a flow chart shown in FIG. 4. An example of displaying an image with respect to an item as well as the FIG. 20 will be described here.

When the FIG. 20 is placed on a placement base (not shown in FIG. 3) of the gaming machine 1, the detecting unit 2 detects figure-identification data from a recording medium such as an IC tag 21 or a two-dimensional code 22 provided in this FIG. 20 (S11).

In order to acquire the image data corresponding to the detected figure-identification data from the server 30, figure-identification data is sent from the sending and receiving section 10 to the server 30 (S12). The server 30 makes a search for the corresponding image data in the image-data storing section 30c. In the case where the corresponding image data is not found, it is assumed that the corresponding image data is not stored; notification indicating that the corresponding figure does not exist is sent from the sending and receiving section 30a to the sending and receiving section 10 of the gaming machine 1 (S13), and the sent notification is displayed on the display unit 5c (S14).

Next, the presence or absence of an item as well as the FIG. 20 is detected. The detecting unit 2 detects item-identification data from the recording medium (the IC tag 21 or the two-dimensional code 22) provided in this item (not shown) (S15). In order to judge whether or not the image data corresponding to the detected item-identification data is stored in the the server 30, as is the foregoing search step the FIG. 20, the item-identification data is sent to the server 30 and a search is made therefor (S16).

The server 30 makes a search for the corresponding image data in the image-data storing section 30c based on the sent item-identification data. In the case where the corresponding image is not found, it is assumed that the corresponding image data is not registered, and notification that the corresponding item does not exist is sent from the sending and receiving section 30a to the sending and receiving section 10 of the gaming machine 1 (S17), and the sent notification is displayed on the display unit 5c (S18).

In the case where the figure-identification data and/or item-identification data have(has) been detected, acquired points of each game are acquired from the gaming device 9 and accumulated points are acquired from a game point storing unit (not shown) (S19).

The sending and receiving section 10 sends points (acquired points and/or accumulated points of each game) to the server 30 (S20), and obtains the sent figure-identification data, the item-identification data, and the image data corresponding to the points from the server 30 (S21).

In addition, in the case where the game-progressing information receiving unit 4 has acquired game-progressing information from the another gaming machines 1A to 1N, this game-progressing information is sent from the sending and receiving section 10 to the server 30 (S22).

The sending and receiving section 10 acquires from the server 30 the image data corresponding to the game-progressing information (S24), and stores the acquired data in the image-data storing unit 7.

The display image data generating section 5a generates the image data display image data for displaying the FIG. 20 or item of player's gaming machine 1 and the FIG. 20 or item of the another gaming machines 1A to 1N by using the image data read out from the image-data storing unit 7 (S25). The display unit 5c displays the generated display image data under the control of display controller 5b (S26).

In the case where the gaming machine 1 that is in game-progressing mode ends a game or in the case where the gaming machine 1 that is not in the game-progressing mode starts a game midway, the steps S19 to S26 are repeated, thereby displaying a change in game-progressing state of the another gaming machines 1A to 1N (S27).

### Third Embodiment

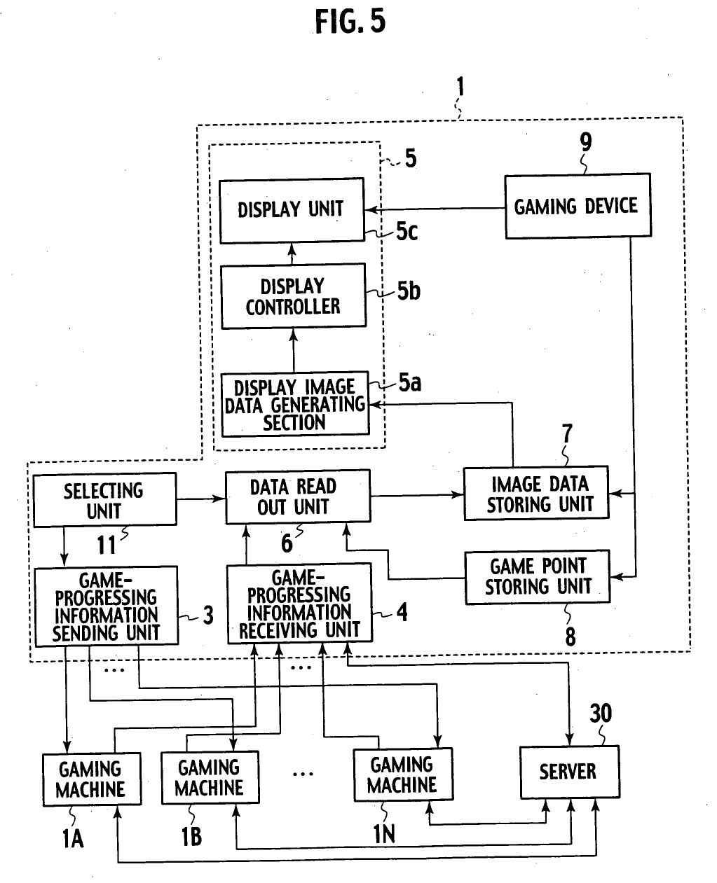

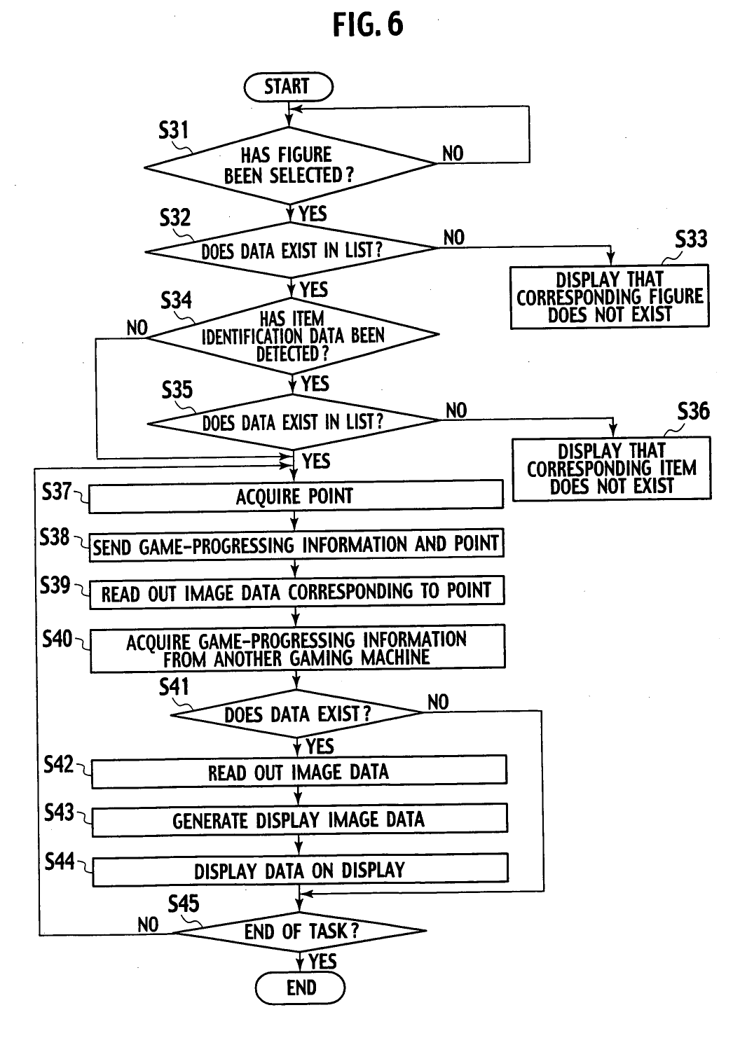

FIG. 5 is a schematic view showing a third embodiment, and FIG. 6 is a flow chart of the third embodiment. In the third embodiment, figure-identification data for identifying a FIG. 20 is acquired by a selecting unit of a gaming machine 1. Then, as in the foregoing first embodiment or the second embodiment, the figure-identification data is sent to the another gaming machines 1A to 1N as game-progressing information. In the case where the game-progressing information has been received from the another gaming machines 1A to 1N that is in a game-progressing mode, a character or the like of the FIG. 20 is displayed on a display unit 5c based on the received game-progressing information, and the fact that a gaming machine that is in the game-progressing mode exists is displayed.

The third embodiment is substantially identical to the first and second embodiments except that acquisition of figure-identification data is carried out by a selecting unit 11 such as a selecting button. A description will be given with respect to an example of a configuration comprising image data in a gaming machine 1, and common constituent elements will be briefly described here.

With reference to FIG. 5, a gaming machine 1, in addition to the gaming device 9 which carries out a variety of gaming operations, comprises a selecting unit 11 which selects a FIG. 20, as a constituent element for displaying that the another gaming machines 1A to 1N that are in the game-progressing mode exists. The selecting unit 11 can be composed of selecting buttons or the like, outputting the figure-identification data which corresponds to the FIG. 20 selected by the player with selecting the selecting buttons.

The gaming machine 1, in addition to the selecting unit 11, as in the first and second embodiments, comprises: a game-progressing information sending unit 3 which sends the game-progressing information such as figure-identification data selected by the selecting unit 11 to the another gaming machines 1A to 1N or the server 30; a game-progressing information receiving unit 4 which receives the game-progressing information sent from the another gaming machines 1A to 1N and/or the server 30; a data read out unit 6 which reads out the figure-identification data from the detection information selected by the selecting unit 11 and/or the game-progressing information received by the receiving unit 4; an image-data storing unit 7 which stores a image data such as a character of the FIG. 20; a display means 5 which displays the image data read out from the image-data storing unit 7 based on the figure-identification data; and a game point storing unit 8 which stores a game point such as a bonus acquired by the gaming device 9. The above constituent elements can be made identical to those of the first embodiment or those of the second embodiment.

Now, an example of an operation of a configuration shown in FIG. 5 will be described with reference to a flow chart shown in FIG. 6. An example of displaying an image with respect to an item as well as a figure will be described here.

With the player selects the selecting buttons, the gaming machine 1 detects the FIG. 20 (S31). In order to determine whether or not the image data corresponding to the selected figure-identification data is stored in the image-data storing unit 7, for example, a search is made for list data on the figure-identification data (S32). In the case where the figure-identification data is not found in the list data, it is assumed that the corresponding image data is not stored, and the fact that the corresponding figure does not exist is displayed on the display unit 5c (S33).

It is also determined whether the player selects the item with the selecting buttons or not. When the item is selected, the item-identification data is detected (S34). In order to determine whether or not the image data corresponding to the detected item-identification data is stored in the image-data storing unit 7, a search is made for list data on the item-identification data, for example (S35). In the case where the item-identification data is not found in the list data, it is assumed that the corresponding image data is not registered, and the fact that the corresponding item does not exist is displayed on the display unit 5c (S36).

In the case where the figure-identification data and/or the item-identification data have(has) been detected, acquired points of each game is acquired from the gaming device 9 and accumulated points are acquired from the game point storing unit 8 (S37).

The game-progressing information sending unit 3 sends to another device (the another gaming machines 1A to 1N or server 30) the acquired figure-identification data or item-identification data. Data such as acquired points, accumulated points, and a game result may be sent (S38).

The image-data storing unit 7 reads out the image data corresponding to the acquired figure-identification data, item-identification data, acquired points, accumulated points, and a game result or the like. The image-data storing unit 7 stores the image data on a character of the FIG. 20 corresponding to the figure-identification data or the image data of the item corresponding to the item-identification data.

Further, in the case where an effect for changing a display state of the FIG. 20 or the item is carried out according to the acquired points, the accumulated points, or the game result, the image data corresponding thereto is stored, and the image data corresponding the figure-identification data, the item-identification data, the acquired points, the accumulated points, and a game result or the like is read out. This image data relates to the FIG. 20 or the item placed on the gaming machine 1.

The game-progressing information receiving unit 4 receives the game-progressing information of the another gaming machines 1A to 1N (S40). In the case where the figure-identification data or the item-identification data is included in the game-progressing information, the figure-identification data or the item-identification data is read out (S41), and then, the image data of the FIG. 20 or the item of corresponding the another gaming machines 1A to 1N is read out from the image-data storing unit 7 (S42).

The display image data generating section 5a generates a display image data indicating the FIG. 20 or the item of the player of the gaming machine 1 or the player of the another gaming machines 1A to 1N based on the data read out from the image-data storing unit 7 (S43). The display unit 5c displays the generated display image data under the control of the display controller 5b.

In the case where the gaming machine 1 that is in the game-progressing mode ends a game or in the case where the gaming machine 1 that is not in the game-progressing mode starts a game midway to change a current state to a game-progressing state, for example, the steps S3 to S44 are repeated, thereby displaying a game-progressing state of the another gaming machines 1A to 1N (S45).

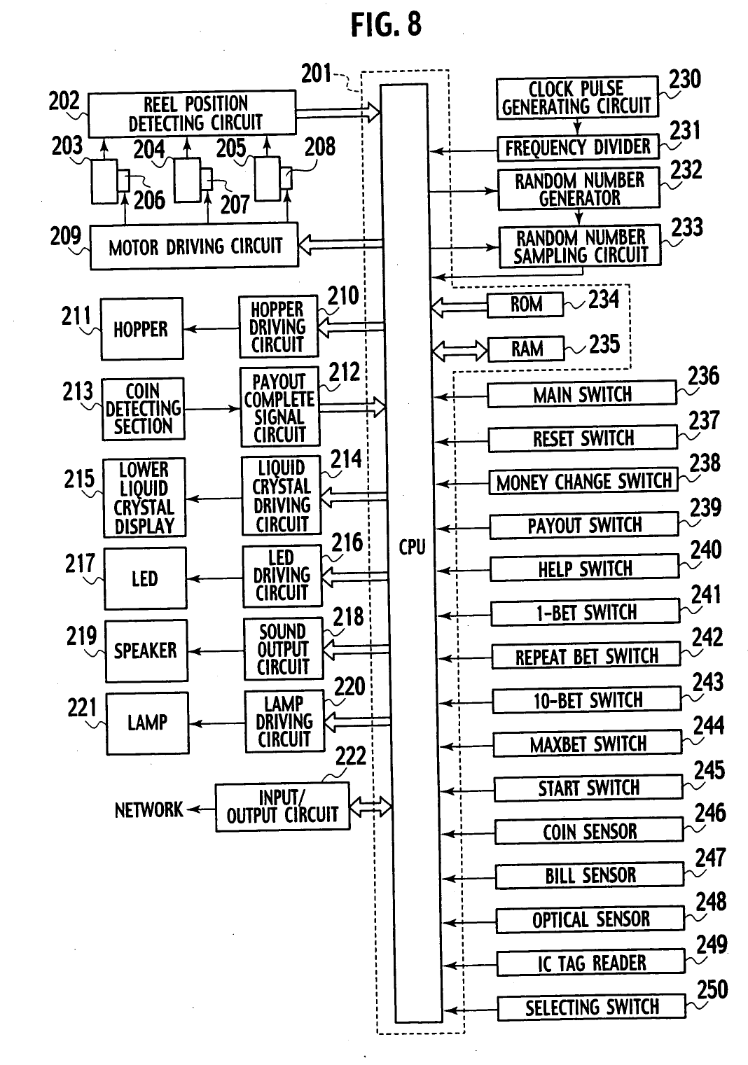

Now, an example of a configuration of the gaming machine 1 will be described with reference to an external schematic view shown in FIG. 7 and a block diagram depicting an internal configuration shown in FIG. 8.

The gaming machine 1 includes a display 5 which displays a game image and an image of a character of the FIG. 20.

The gaming machine 1 further includes a main display 103 which is comprised of a liquid crystal display on a front side of a cabinet 100, as shown in the external view of FIG. 7; and an decoration panel 101 upwardly of the main display 103. Speakers 102L and 102R for a sound effect of a game or a guidance of a game are provided at both of the left and right sides of the decoration panel 101.

In FIG. 7, although there is shown an example in which the decoration panel 101 is set upwardly of the main display 103, the decoration panel 101 may be provided downwardly or at the side of the main display 103. In addition, although there is shown an example in which the speakers 102L and 102R are set upwardly of the main display 103, the speakers 102L and 103R may be provided downwardly or at the side of the main display 103. Alternatively, the speakers 102L and 102R may be provided upwardly or downwardly of the decoration panel 101.

The gaming machine 1 further includes an operating panel 104 at the lower side of the main display 103, and a placement base 105 for placing the FIG. 20 (not shown) is provided at the left side of the operating panel 104. With respect to the placement base 105, a detecting face 105a may be provided on the placement base 105 for placing the FIG. 20.

The main display 1 may be composed of a transparent liquid crystal panel, for example. In addition, a rotary reel device may be provided downwardly of the liquid crystal panel.

On the placement base 105, there is provided the detecting unit 2 such as an IC tag reader or an optical detector device, for detecting the figure-identification data or the like recorded in a recording medium such as the IC tag 21 or the two-dimensional code 22 and the like provided in the FIG. 20. Then, the FIG. 20 placed on the placement base 105 is detected, and the figure-identification data is read out from the recording medium provided on a bottom face of a figure main body or inside of the FIG. 20.

A setting position of the detecting unit 2 is not limited the placement base 105. That is, any position can be set as long as the position can acquire the figure-identification data or item-identification data from the recording medium provided in the FIG. 20 or item.

In addition, at the right portion of the operating panel 104, there is provided: a coin inserting slot 108 for inserting a coin (game medium such as coin) required for executing a game; a card slot (card inserting slot) 109 for inserting an IC card 110; and an operating unit 107 comprising operating buttons.

A description will be given with reference to a block diagram of an internal configuration shown in FIG. 8. Here, a control system of a slot machine is schematically shown as one aspect of a game machine 1 applicable to the present invention.

A CPU 201 controls the slot machine and is connected to a ROM 234 and a RAM 235. The ROM 234 stores: a main processing program; a normal game processing program; an effect program for executing a variety of effects by using a liquid crystal display 215, an LED 217, or a lamp 221 based on a game state; a lottery table for executing a lottery for a game stop display icon; a share table decided based on a winning-combination; a variety of other programs required for communicating with the other slot machines; a table or the like which indicates a data table, figure-identification data, image data of a character of the FIG. 20, item-identification data, image data of an item, and a relationship between acquired points or accumulated points and image data.

In addition, the RAM 235 is a memory in which a variety of data computed by the CPU 201, the number of credits currently credited in the slot machine (gaming machine) and a gate rate currently set in the slot machine are temporarily stores therein.

A clock pulse generating circuit 230 which generates a reference clock pulse and a frequency divider 231 are connected to the CPU 201. In addition, a random number generator 232 generating a ransom number and a random number sampling circuit 233 are connected to the CPU 201, respectively. The random number sampled via the random number sampling circuit 233 is used for a variety of lotteries such as the winning-combination or effect.

Further, a main switch 236, a reset switch 237, a money change switch 238 connected to a money change button; a payout switch 239 connected to a payout button; a help switch 240 connected to a help button; an 1-BET switch 241 connected to an 1-BET button; a repeat bet switch 242 connected to a repeat bet button; a 10-BET switch 243 connected to a 10-BET button; a MAXBET switch 243 connected to a MAXBET button; and a start switch 244 connected to a start button are connected to the CPU 201, respectively.

The CPU 201 makes control to execute a variety of corresponding operations based on a switch signal outputted from each switch to each button by means of a pushing operation or the like.

Stepping motors 206 to 208 which makes rotation of each of reels 203 to 205 are connected to the CPU 201 via a motor driving circuit 209. In addition, a reel position detecting circuit 202 is connected to the CPU.

When a motor driving signal is outputted from the CPU 201 to the motor driving circuit 209, each of the stepping motors 206 to 208 is rotationally driven by means of the motor driving circuit 209. In this manner, the reels 203 to 205 are rotated, respectively.

After rotation of each of the reels 203 to 205 has started, a driving pulse supplied to each of the stepping motors 206 to 208 is counted. This count value is written into a predetermined region in the RAM 235. In addition, from each of the reels 203 to 205, a reset pulse is outputted every one rotation. The reset pulse is inputted to the CPU 201 via the reel position detecting circuit 202. When a reset pulse is inputted to the CPU 201, the count value written in the RAM 235 is cleared to “0”. The CPU 201 recognizes a rotation position of an icon in each of the reels 203 to 205 based on: the count value corresponding to the rotational position in the range on one rotation of each of the reels 203 to 205; and an icon table obtained by associating the rotational position of each of the reels 203 to 205 stored in the ROM 234 with an icon formed on the peripheral surface of each of the reels 203 to 205.

Further, to the CPU 201, there are connected: a coin sensor 246 disposed at a coin inserting section; and a bill sensor 247 disposed at a bill inserting section, respectively. The coin sensor 246 detects a coin inserted through the coin inserting section, and the CPU 201 counts the number of coins inserted based on a coin detecting signal outputted from the coin sensor 246. The number of credits of the player stored in the RAM 235 is increased based on the counted number.

In addition, the bill sensor 247 detects type and/or amount of a bill inserted through the bill inserting section. The CPU 201 computes the number of coins equivalent to an amount of detected type and/or amount of bill based on a bill detecting signal outputted from the bill sensor 247, and pays out the computed number of coins from a hopper 211.

In addition, a detecting unit for detecting the FIG. 20 is connected to the CPU 201. The detecting unit includes: an optical sensor 248 which optically detects a two-dimensional code 22; an IC tag reader 249 which detects an IC tag 21 in a wireless manner; or a selecting switch 250.

The hopper 211 is connected to the CPU 201 via a hopper driving circuit 210. When a driving signal is outputted from the CPU 201 to the hopper driving circuit 210, the hopper 211 pays out a predetermined number of coins from a coin payout slot.

In addition, a coin detecting section 213 is connected to the CPU 201 via a payout complete signal circuit 212. The coin detecting section 213 is disposed inside of a coin payout slot, and in the case where it is detected that a predetermined number of coins has been paid out through the coin payout slot, a coin payout signal is outputted from the coin detecting section 213 to the payout complete signal circuit 212. The payout complete signal circuit 212 outputs the coin payout signal to the CPU 201. Further, a liquid crystal display 215 is connected to the CPU 201 via the liquid crystal driving circuit 214, and the liquid crystal display 215 is controlled by means of the CPU 201.

An LED 217 is connected to the CPU 201 via an LED driving circuit 216. The LED 217 is controlled to be lit by means of the LED driving circuit 216 based on a driving signal from the CPU 201, and a variety of effects are carried out.

In addition, the speaker 219 is connected to the CPU 201 via a sound output circuit 218. The speaker 219 outputs an effect sound when a variety of effects are carried out by means of an output signal from the sound output circuit 218.

In addition, a lamp 221 is connected to the CPU 201 via a lamp driving circuit 220. The lamp 221 is controlled to be lit by means of an output signal from the lamp driving circuit 220. In addition, an input and output circuit 222 which carries out sending and receiving with a network (not shown) is connected to the CPU 201. A game-progressing information sending unit 3, a game-progressing information receiving unit 4, a game information sending unit 13, a game information receiving unit 14, and a sending and receiving section 10 are connected to the other slot machine or a server through this input and output circuit 222.

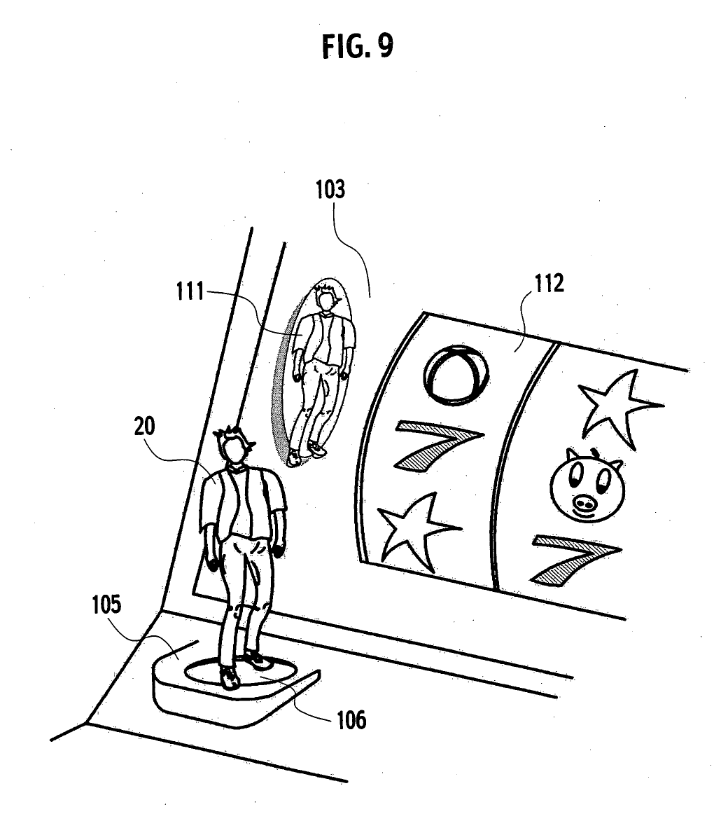

Now, an example of a game screen according to the present invention will be described with reference to FIG. 9 to FIG. 16.

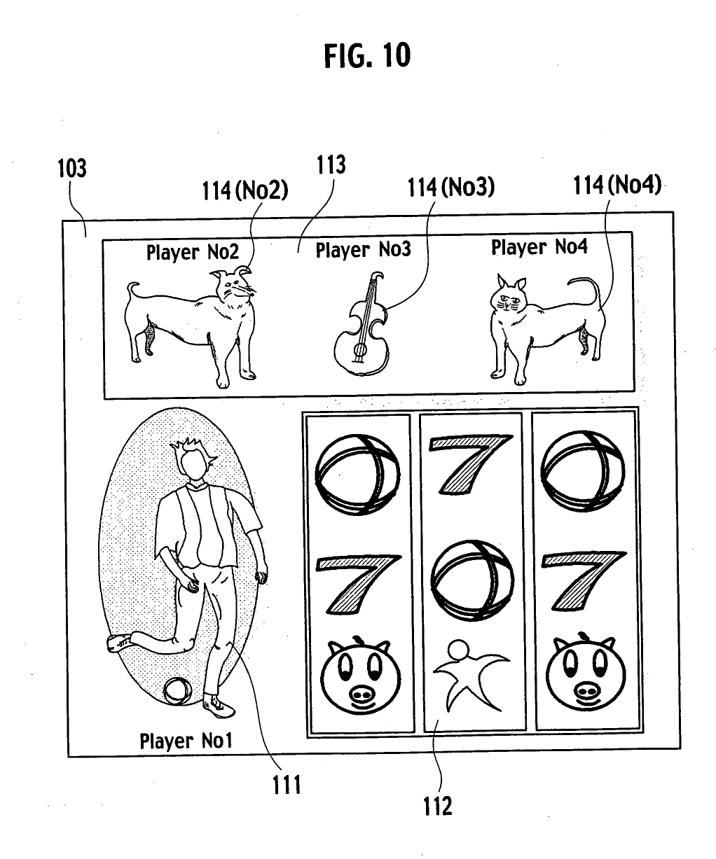

First, an example of a display image in the player's slot machine (gaming machine) according to the present invention will be described with reference to FIG. 9 and FIG. 10.

When the FIG. 20 is placed on the placement base 105, a reading unit 106 reads the figure-identification data from a recording medium provided at the FIG. 20.

In FIG. 9, a game display 112 such as a reel display of the slot machine is displayed on the main display 103, and a character image 111 of the FIG. 20 is displayed on the main display 103 based on the read figure-identification data.

A display position of the character image 111 can be defined as a predetermined position arbitrarily set on the main display 103. In the case where the game display 112 is a reel display of the slot machine, the main display 103 is composed of a transparent liquid crystal panel. Then, a rotating reel is disposed on a lower side of the liquid crystal display panel, and the rotating reel is displayed through the liquid crystal panel. In addition, an opening is provided partly of the liquid crystal panel, and the rotating reel may be arranged inside the opening.

FIG. 10 shows a display example of the main display 103. The game display 112 such as a reel display is displayed. In addition, a character image 111 of the FIG. 20 placed on the placement base 105 is displayed, and a character image 114 of the FIG. 20 placed on the other slot machine (the another gaming machines 1A to 1N) which is in the game-progressing mode is displayed in a game-progressing information display region 113.

In FIG. 10, a character image 111 indicates a character image of a player No. 1 playing a game; and the game-progressing information display region 113 displays character images 114 (No. 2, No. 3, No. 4) of players 2 to 4 (non-players, competitors) playing the same game by using the other slot machines which are in the game-progressing mode.

By seeing the game display 112 displayed on the main display 103 and the character image 111 of the FIG. 20 of the player No. 1, it is possible to enhance game effect property. Further, the player No. 1 can recognize the number of the slot machines that are currently in the game-progressing mode by seeing the character image 113 of the competitors (the players who play the other slot machines). In addition, the player No. 1 can speculate the competitors by seeing the appearances of the character images 114 (No. 2), 114(No. 3), 114(No. 4).

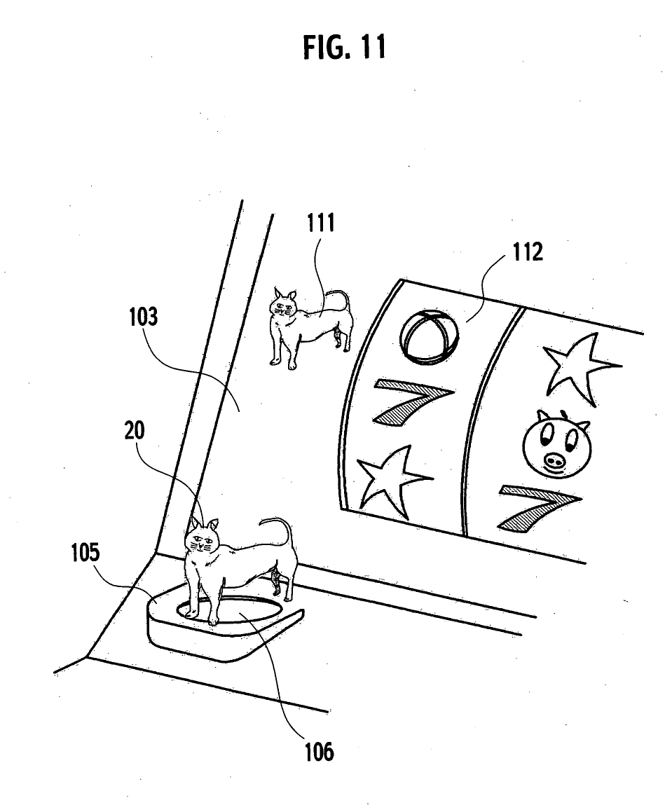

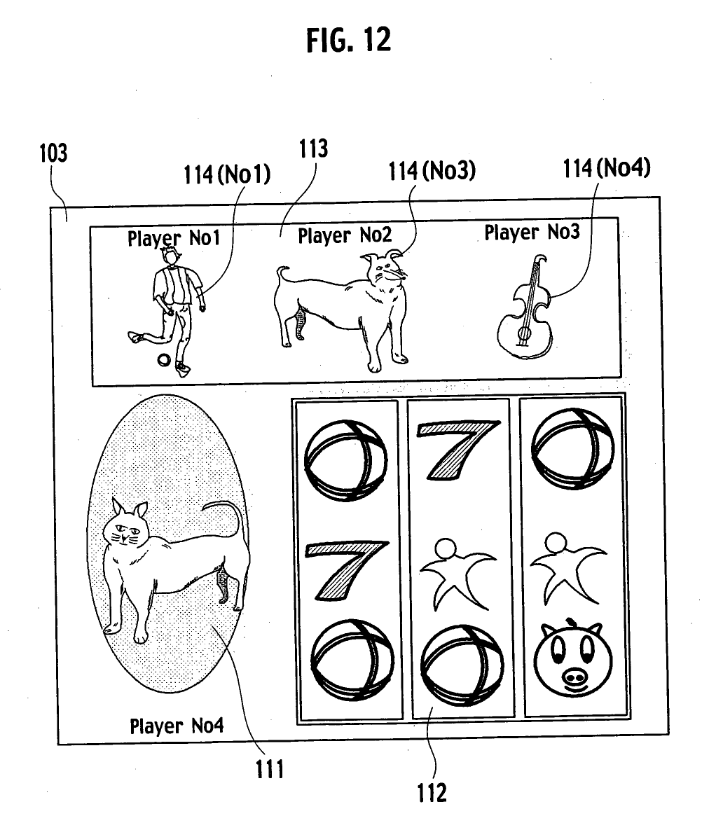

FIG. 11 and FIG. 12 each show an example of a display screen of the another gaming machine 1A to 1N.

In the another gaming machines 1A to 1N, when the FIG. 20 is placed on the placement base 105 of these gaming machines, the reading unit 106 reads the figure-identification data from the recording medium provided at the FIG. 20, and displays the character image 111 of the FIG. 20 based on the read figure-identification data.

That is, as shown in FIG. 11, on the main display 103 of the competitor's slot machine, in addition to the game display 112, the figure-identification data is detected by means of the reading unit 106 such as an IC tag reader or an optical sensor, and based on this figure-identification data, the image data of a character is read out, and the character image 111 is displayed.

FIG. 12 shows another example of a display image of the main display 103 of the competitor's slot machine. In addition to the game display 112, the character image 111 of the competitor generated based on the FIG. 20 placed on the placement base 105, the character image 114(114(No. 1), 114(No. 3), 114(No. 4)) of the player No. 1, No. 3, and No. 4 whose gaming machine are in the game-progressing mode are displayed on the game-progressing information display region 113, respectively.

By seeing the game display 112 displayed on the main display 103 and the character image 111 of the FIG. 20 of the player No. 4, it is possible to enhance game effect property. Further, the player No. 4 can recognize the number of the slot machines that are currently in the game-progressing mode by seeing the character image 113 of the competitors (the players who play the another slot machines). In addition, the player No. 4 can speculate the competitors by seeing the appearances of the character images 114 (No. 1), 114(No. 2), and 114(No. 4).

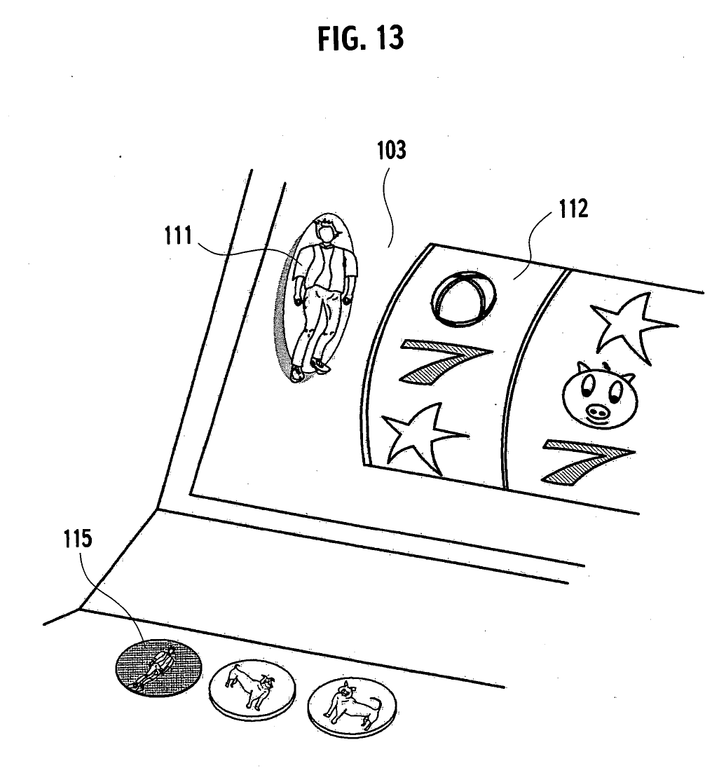

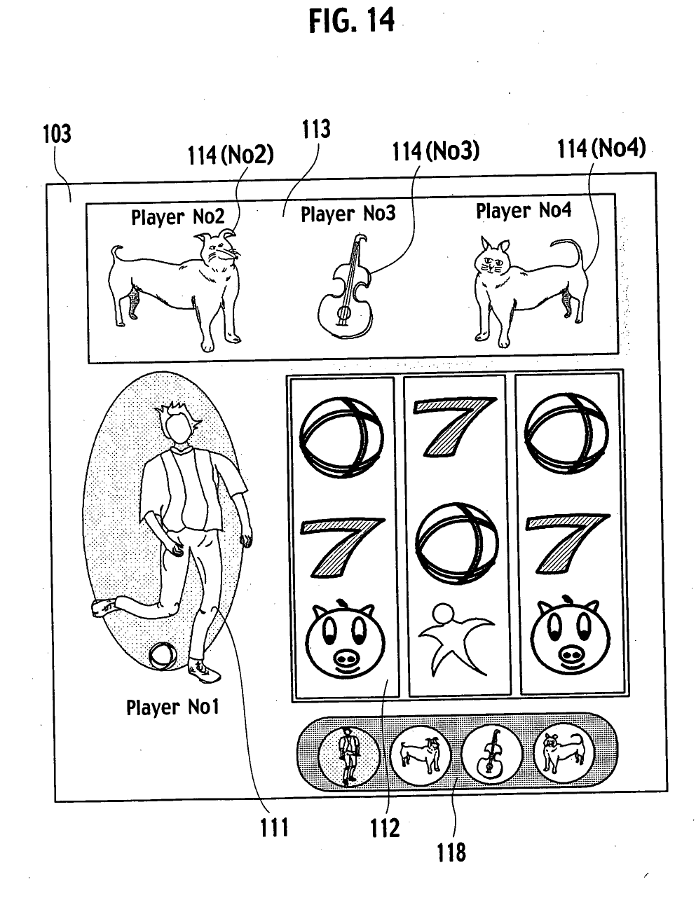

In FIG. 9 to FIG. 12, the FIG. 20 placed on the placement base 105 is detected, thereby displaying the character image 111. In constant, in FIG. 13 and FIG. 14, the FIG. 20 is detected by means of a selecting button, thereby displaying the character image 111.

Selecting buttons 115 for selecting the FIG. 20 are provided on the operating panel 104 of the slot machine (gaming machine 1). From among these selecting buttons 115, a selecting button displaying the FIG. 20 to be displayed is pressed, thereby the character image 111 is displayed on the main display 103.

As in FIG. 9, the game display 112 such as a reel display of the slot machine is displayed on the main display 103 shown in FIG. 13, and the character image 111 of the FIG. 20 is displayed based on the figure-identification data selected by pressing the selecting button 115 and read. A display mode of the character image 111 can be made as in FIG. 9.

FIG. 14 shows another example display image of the main display 103. This main display 103 displays the game display 112 such as the reel display; the character image 111 of the FIG. 20 selected by pressing a selecting button 115; the character image 114 of the FIG. 20 of the slot machines which are in the game-progressing mode displayed in a game-progressing information display region 113; and a selection display 118.

In FIG. 14, the character image 111 displays the character of the FIG. 20 selected by player No. 1. The game-progressing information display region 113 displays the character image 114 of the players No. 2 to No. 4 playing the same game with the other slot machines which are in the game-progressing mode. Meanwhile, the players No. 2 to No. 4 can select his/her character image 114 by placing his/her FIG. 20 on the placement base 105 or selecting by the selecting button 115.

In this manner, by seeing the game display 112 displayed on the main display 103 and the character image 111 of the FIG. 20 of the player No. 1, it is possible to enhance game effect property. Further, the player No. 1 can recognize the number of the slot machines that are currently in the game-progressing mode by seeing the character image 113 of the competitors (the players who play the other slot machines). In addition, the player No. 1 can speculate the competitors by seeing the appearances of the character images 114 (No. 2), 114(No. 3), and 114(No. 4). As another display mode, in addition to select the FIG. 20 with the selecting buttons 115, it is also possible to configured to select a variety of the items being attached to the FIG. 20, thereby desired character image 111 can be displayed.

Now, a display mode on the main display 103 will be described here. A display mode includes a mode for displaying the item together with the FIG. 20.

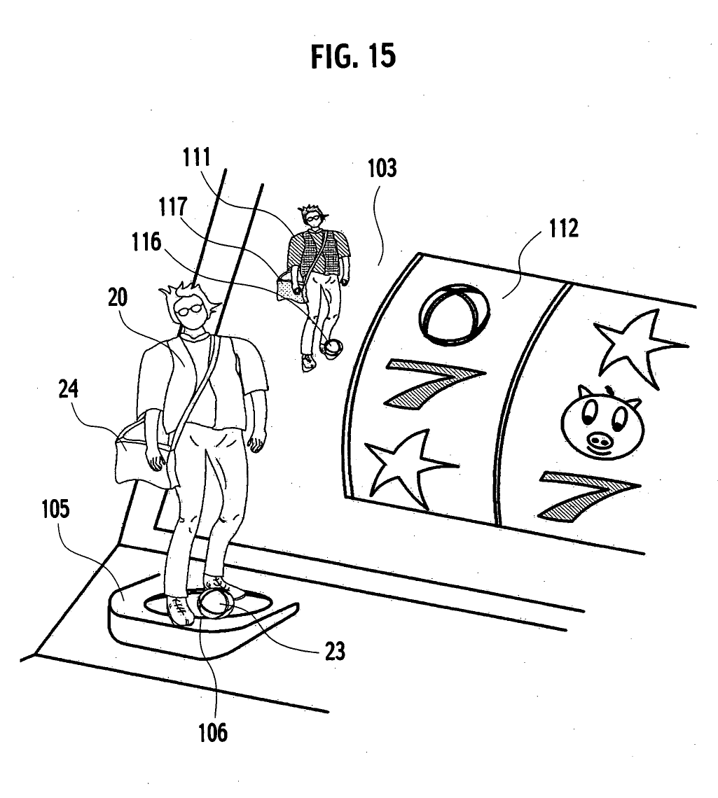

In FIG. 15, when an item 23 and 24 are placed on the placement base 105 together with the FIG. 20, the reading unit 106 reads the item-identification data from the recording medium provided at each of these items 23 and 24. The item-identification data used here is identification data for specifying an item. As in the character image 111 of the FIG. 20, image data of the items 23, 24 are read out based on the item-identification data, and item images 116 and 117 are displayed on the main display 103, respectively.

In addition to the character image 111 of the FIG. 20, the item images 116 and 117 are displayed, thereby making it possible to enhance a game feeling of a player and effect property of the slot machine.

In addition to displaying the item images 116 and 117, a function used on game operation is added to each item, thereby making it possible to enhance game property.

A display mode includes a mode for changing a display image in accordance with a game state of the slot machine in addition to the above-described items.

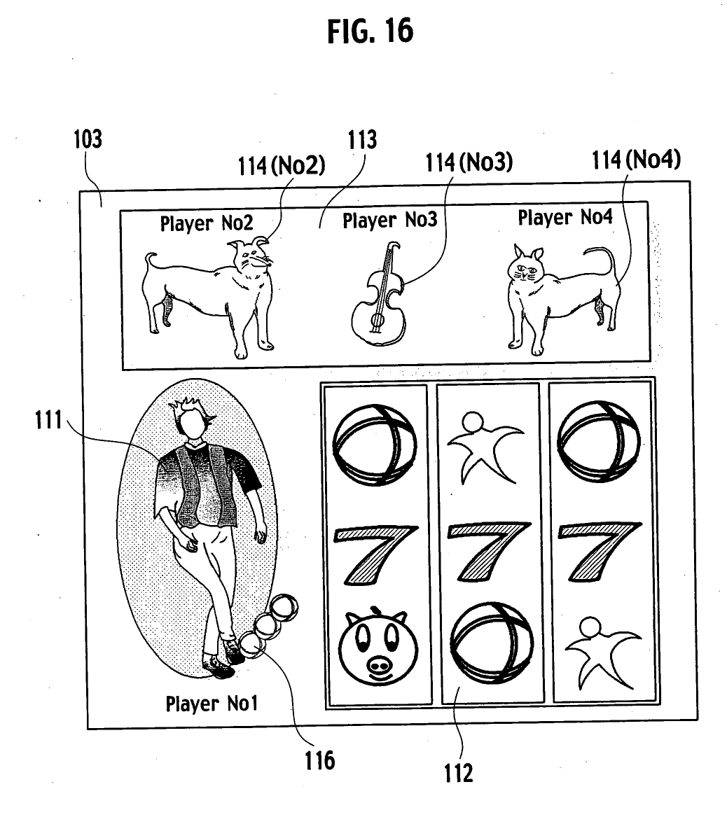

In FIG. 16 show a case where a winning-combination has been established in a game. In addition to displaying the winning-combination on the game display 112, the character image 111 of the FIG. 20 is also changed according to the winning-combination. For example, in FIG. 16, a character image 111 and an item image 116 are changed from a normal display image (see the character image 111 of the player No. 1 in FIG. 14) to a display image indicating that a winning-combination has been established. A display image to be changed can be set according to the winning-combination. Game effect property can be enhanced by adopting this display mode.

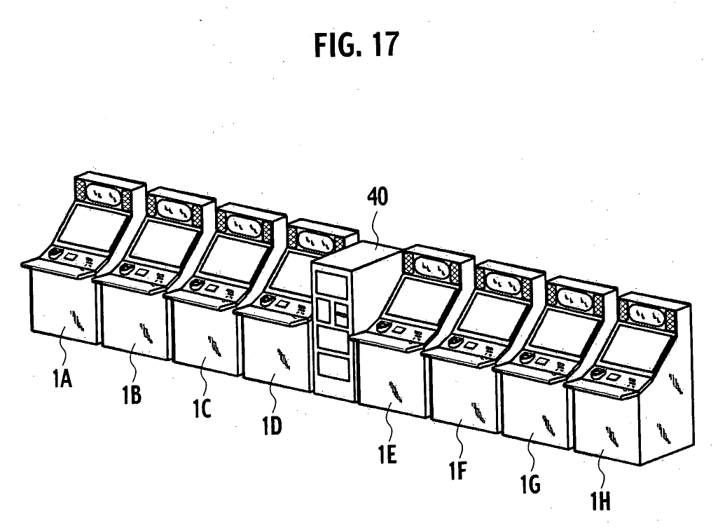

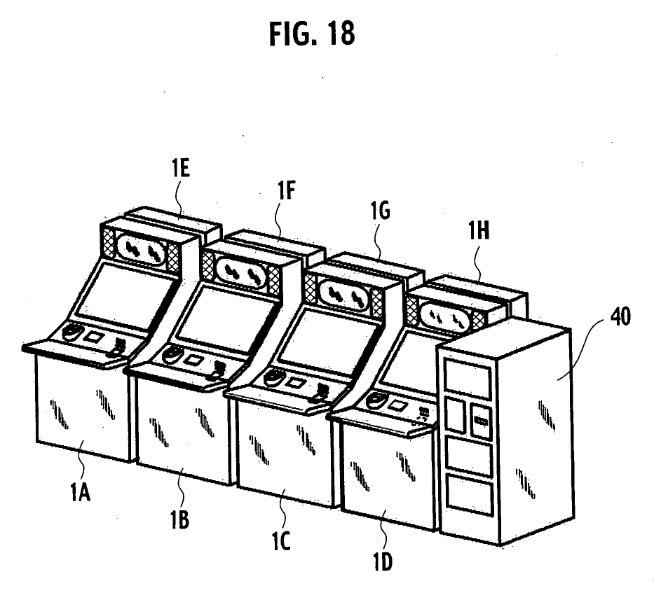

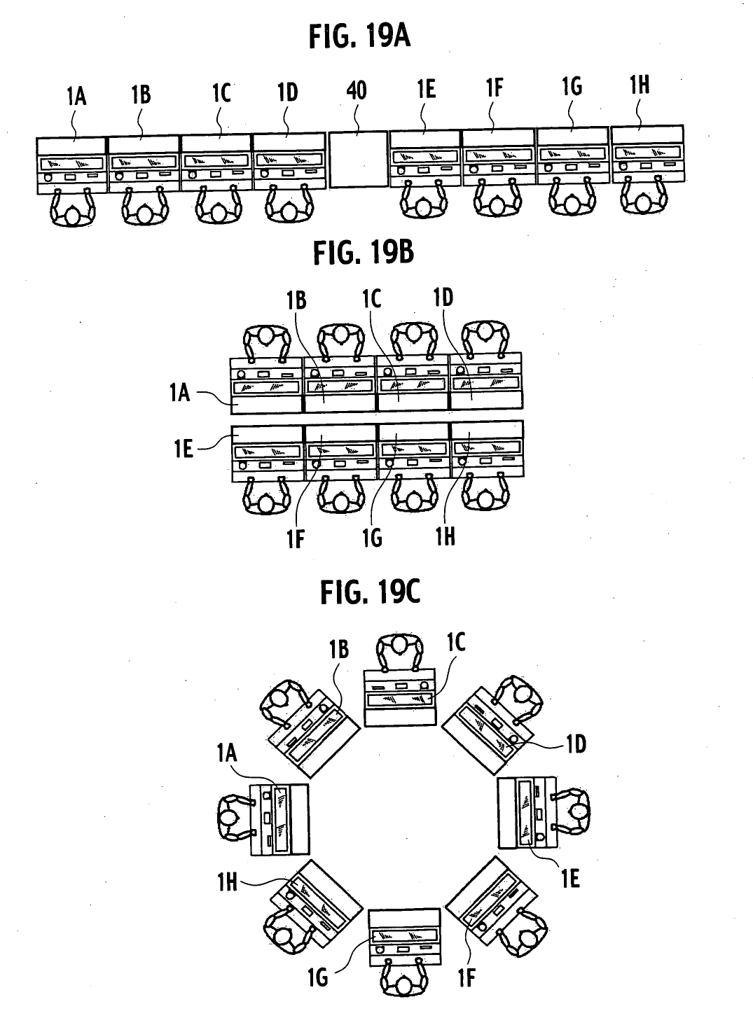

Now, an example of disposing a plurality of gaming machines will be described with reference to FIG. 17 to FIG. 19. A plurality of gaming machines 1 can be disposed in a variety of disposition patterns. FIG. 17 and FIG. 19A each show an example in which gaming machines 1A to 1H are arranged in a transversal direction in a linear shape while sandwiching a card vending machine 40. FIG. 18 and FIG. 19B each show an example in which two columns of gaming machines 1A to 1D and gaming machines 1E to 1H disposed in a linear shape are arranged on their backside each other. In addition, FIG. 19C shows an example in which gaming machines 1A to 1H are arranged in a ring shape.

These gaming machines are connected to each other via a network, thereby carrying out a common game, and share common accumulated bonus such as a jackpot, thereby executing a game.

According to a gaming machine of the present invention, in any of the above-described disposition examples, each player can check the number of the another gaming machines which are currently in the game-progressing mode on a display screen in a state in which each player concentrates his or her attention to one's own game without turning one's eyes from the display screen of a gaming machine which one plays.

In the above example, although an example of eight gaming machines 1A to 1H is shown as a plurality of gaming machines, an arbitrary number of gaming machines can be disposed without being limited thereto.

FIG. 20 shows an example of a data structure of figure data for displaying the character image 111 (114) of the FIG. 20 and item images 116 and 117 in the gaming machine 1 according to the present invention.

Figure data 300 comprises: figure-identification data 301 for specifying the figure data 300; character image data 302 for displaying the character image 111 of the FIG. 20; textile data 303 indicating a surface state of a cloth or the like of the character image 111; color data 304 indicating a color tome of a surface of a cloth or the like of the character image 111; and item-identification data 305 for specifying the item attached to each FIG. 20.

In order to change a display image according to a game state of the gaming machine 1, the character image data 302 has a plurality of character image data F1 to F3 to be associated with points P11 to P13 of the gaming machine 1, for example. In this manner, the character image 111 of the FIG. 20 can be changed according to accumulated points which the gaming machine 1 stores or acquired points acquired in each game.

In order to change a surface state of the character image 111 according to a game state of the gaming machine 1, the textile image data 303 has a plurality of textile data Ta1, Ta2, Tb1, Tb2, Tc1, and Tc2 to be associated with each of sites “a”, “b”, and “c” of the character image 111 and points P21 and P22 of the gaming machine 1, for example. In this manner, a surface state of the character image 111 of the FIG. 20 can be changed according to the accumulated points which the gaming machine 1 stores and the acquired points acquired in each game.

In order to change a surface state of the character image 111 according to a game state of the gaming machine 1, for example, the color data 304 has a plurality of color data Ca1, Ca2, Cb1, Cb2, Cc1, and Cc2 to be associated with each of sites “a”, “b”, and “c” which configure the character image 111 and points P31 and P32 of the gaming machine 1. In this manner, a color of the character image 111 of the FIG. 20 can be changed according to the accumulated points which the gaming machine 1 stores and the acquired points acquired in each game.

In addition, the item data 305 comprises data on items 23 and 24 displayed to be attached to the character image 111 of the FIG. 20. This data can include information such as a display position relevant to the character image 111.

A gaming machine according to the present invention can be applied to any types of gaming machines such as a vertical pinball machine, a slot machine, a game device, a pachinko gaming machine and the like.

According to the present invention, while a player plays a game at a gaming machine, the player can check the presence or absence of a competitor without turning one's eye from a gaming machine.

According to the present invention, a detected figure can be used as an indicator for indicating game-progressing information. Further, game property can be enhanced by changing a display state of the figure according to a game state such as points of gain bonus or the like.

Now, other embodiments according to the present invention will be described below.

Hereinafter, fourth and sixth embodiments of the present invention will be described in detail with reference to the accompanying drawings.

In any of the fourth to sixth embodiments, as in the above-described first embodiment, the figure-identification data for identifying the FIG. 20 is acquired, and this figure-identification data is sent to the another gaming machine (another gaming machine) as the game-progressing information. In the case where the game-progressing information has been received from the another gaming machine that is in the game-progressing mode, the character image 111 or the like of the FIG. 20 is displayed on the display means 5 based on the received game-progressing information, and the fact that a player playing the same game exists is displayed.

In addition, each gaming machine sends game-progressing information indicating a game state of the gaming machine to the another gaming machine directly or via the server 30. Each gaming machine displays a game state of the another gaming machine based on the sent game information.

The fourth and fifth embodiments have a configuration for detecting a figure placed on a gaming machine of the embodiment, and the sixth embodiment has a configuration in which image data for displaying a character or the like of a figure as an image is stored in each gaming machine, and the fifth embodiment is an embodiment in which image data is stored in a server.

In addition, the sixth embodiment has a configuration for selecting a figure by selecting buttons or the like which a gaming machine comprises.

### Fourth Embodiment

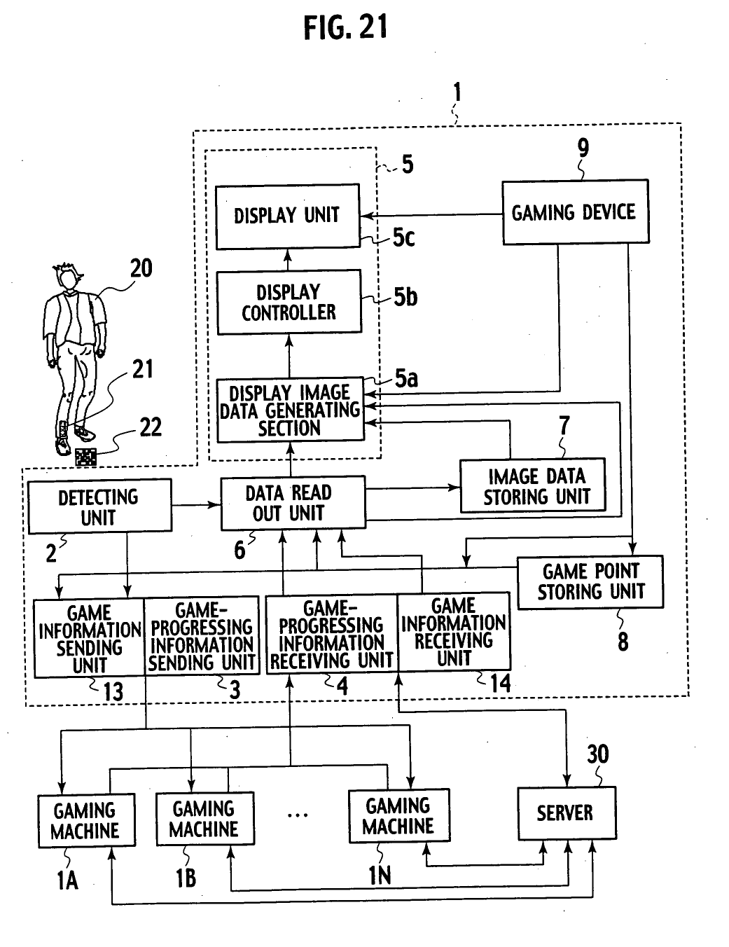

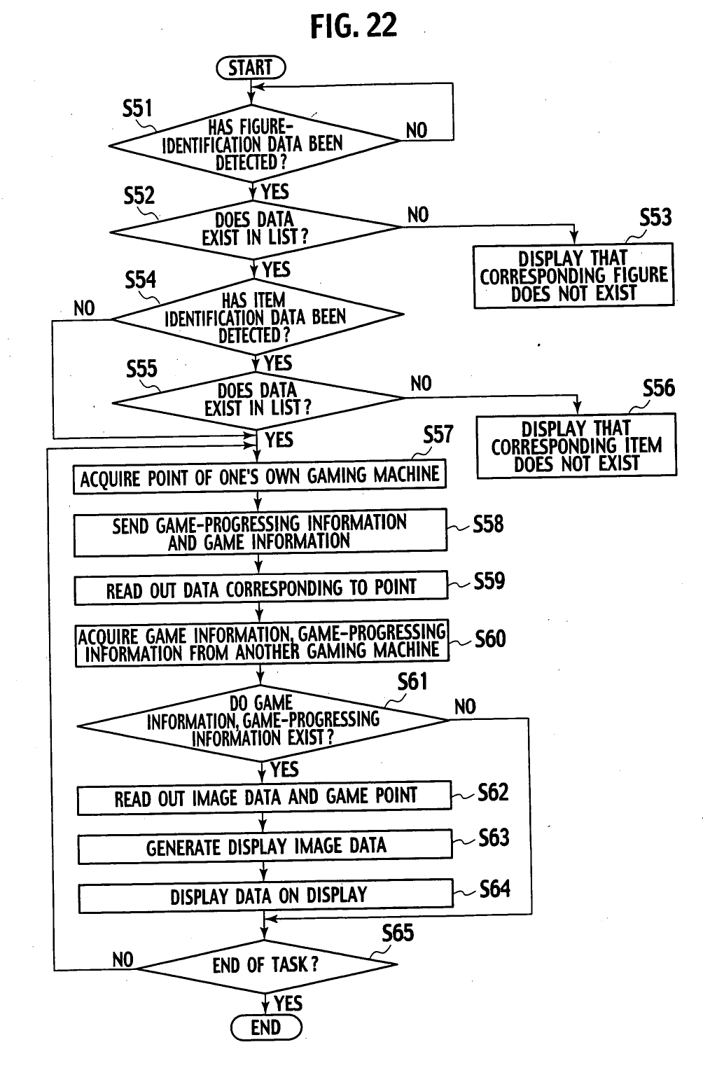

First, the fourth embodiment will be described below. FIG. 21 is a schematic view showing the fourth embodiment, and FIG. 22 is a flow chart showing the fourth embodiment.

As is the schematic view of the first embodiment, a gaming machine 1 according to the present embodiment is schematically identical to that according to the first embodiment, and is characterized by having a game-progressing information sending unit 13 and a game-progressing information receiving unit 14. The game-progressing information sending unit 13 sends game information such as acquired points and accumulated points or a game result, and the game-progressing information receiving unit 14 receives the transmitted game-progressing information. In addition, the display means 5 carries out image display by using image data read out from the image-data storing unit 7 based on the figure-identification data as in the first embodiment and carries out image display by using the received game information. Other constituent elements are identical to those according to the above-described first embodiment.

In more detail, the game information sending unit 13 sends to the another gaming machines 1A to 1N or the server 30 a result of each game and acquired points acquired from the gaming device 9 and accumulated points or the like stored in the game point storing unit 8 as game information indicating a game state of the gaming machine 1.

The game information receiving unit 14 receives the game information from the another gaming machines 1A to 1N or the server 30. The received game information is read out by means of a data read out unit 6.

In addition, the data read out unit 6 according to the present embodiment inputs the figure-identification data for identifying the FIG. 20 of the gaming machine 1 from the detecting unit 2; inputs the game-progressing information of the another gaming machines 1A to 1N from the game-progressing information receiving unit 4 to read out the figure-identification data; and sends the read out data to the image-data storing unit 7. The game information received by the game-progressing information receiving unit 14 is sent to the image-data storing unit 7, and the image-data storing unit 7 reads out image data of a character according to a game state, and sends the read out data to the display image data generating section 5a. Numeric data such as acquired points or accumulated points are sent directly to the display image data generating section 5a, and image data for displaying a numeric value can be generated.

With respect to points of the gaming machine 1, as in the above-described first embodiment, in the case where accumulated points such as accumulated amount of bonus are stored in the game point storing unit 8, the accumulated points are read out from the game point storing unit 8, and the read out points are sent to the image-data storing unit 7. In addition, the acquired points acquired for each item of data can be acquired from the gaming device 9.

The image-data storing unit 7 outputs to the display image data generating section 5a image data such as a character of the FIG. 20 while the figure-identification data from the data read out unit 6 is defined as a search key. In addition, accumulated points and acquired points are inputted, making it possible to output image data set while differentiating colors or a textiles or the like in advance according to points.

In addition, in the display means 5 according to the present embodiment, the display image data generating section 5a generates display image data for displaying on the display unit 5c by using the image data inputted from the image-data storing unit 7; a point value inputted from the data read out section 6; acquired point values inputted from the gaming device 9, and accumulated point values inputted from the game point storing section 8. The display image data generating section 5a may generate display image data by combining other items of data in addition to image data, thereby making it possible to enhance game effect property.

Now, an example of an operation of a configuration shown in FIG. 21 will be described with reference to a flow chart shown in FIG. 22. Here, a description will be given with respect to an example of displaying both of the item and the FIG. 20.

When the FIG. 20 is placed on the placement base of the gaming machine 1, the detecting unit 2 detects the figure-identification data recorded to a recording medium such as an IC tag 21 or a two-dimensional code 22 provided at the FIG. 20 (S51).

In order to determine whether or not the image data corresponding to the detected figure-identification data is stored in the image-data storing unit 7, for example, a search is made for list data of the figure-identification data (S52). In the case where the figure-identification data is not found in the list data, it is assumed that the corresponding image data is not registered, and the fact that the corresponding FIG. 20 does not exist is displayed on the display unit 5c (S53).

The presence or absence of the item as well as the FIG. 20 is detected. The detecting unit 2 detects the item-identification data recorded in the recording medium provided at the item (not shown) (S54). In order to determine whether or not the image data corresponding to the detected item-identification data is stored in the image-data storing unit 7, for example, a search is made for list data of the item-identification data (S55). In the case where the item-identification data is not found in the list data, it is assumed that the corresponding image data is not registered, and the fact that the corresponding item does not exist is displayed on the display unit 5c (S56).

In the case where the figure-identification data and/or item-identification data have(has) been detected, acquired points of each game is acquired from the gaming device 9, and accumulated points are acquired from the game point storing unit 8 (S57).

The game-progressing information sending unit 3 sends the acquired figure-identification data or item-identification data to another device (the another gaming machines 1A to 1N or the server 30). In addition, the game information sending unit 13 sends data such as the acquired points, accumulated points, or a game result as the game information (S58).

The image-data storing unit 7 reads out the image data which corresponds to the acquired figure-identification data, item-identification data, acquired points, accumulated points, and a game result or the like. The image-data storing unit 7 stores the image data of the character of the FIG. 20 which corresponds to the figure-identification data and/or the image data of the item which corresponds to the item-identification data.

Further, in the case where an effect for changing a display state of the figure and/or the item is carried out according to the acquired points, accumulated points, or a game result, the image data corresponding to these points or game result is provided in advance and is stored, and the corresponding image data is read out while the figure-identification data, item-identification data, acquired points, accumulated points, or a game result and the like is defined as a search key. This image data relates to the FIG. 20 or the item placed on the gaming machine 1 (S59).

The game-progressing information receiving unit 4 receives the game-progressing information from the another gaming machines 1A to 1N or the server 30 (S60). In the case where the figure-identification data or item-identification data is included in the game-progressing information, the figure-identification data or item-identification data is read out (S61), and the image data of the FIG. 20 or the item relating to the corresponding other gaming machines 1A to 1N are read out from the image-data storing unit 7 (S62).

Further in the step S62, the game information receiving unit 14 receives the game information from the another gaming machines 1A to 1N or the server 30 (S60), and reads out the data indicating a game state such as acquired points, accumulated points, and a game result from the game information (S62).

The display image data generating section 5a generates the display image for displaying the FIG. 20 and/or the item of the gaming machine 1; the FIG. 20 and/or the item of the another gaming machines 1A to 1N. At this time, the display image can be changed according to the following information: 1) a game state of the another gaming machines 1A to 1N and/or a game state of the gaming machine 1; 2) a point value in the display image (S63). The display unit 5c displays the generated display image data under the control of the display controller 5b (S64).

In the case where a current state has been changed, for example, in the case where the another gaming machines 1A to 1N that are in the game-progressing mode ends a game or the another gaming machines 1A to 1N which are not in the game-progressing mode starts a game midway, the steps S57 to S64 are repeated, thereby displaying a changed game-progressing state of the another gaming machines 1A to 1N (S65).

### Fifth Embodiment

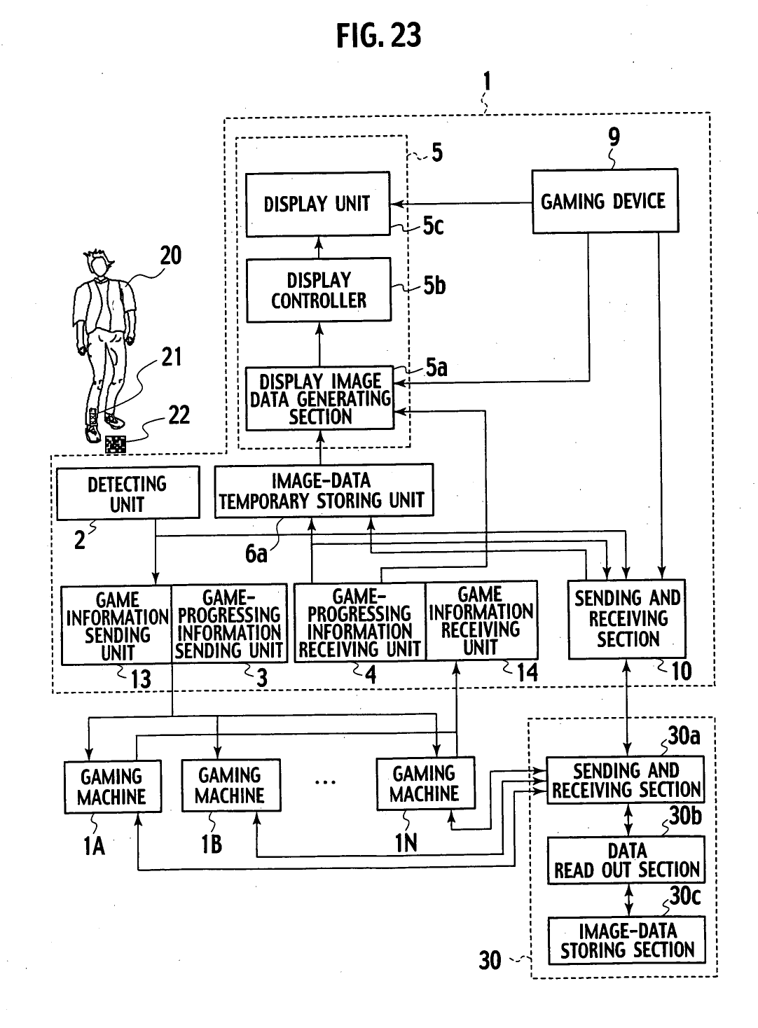

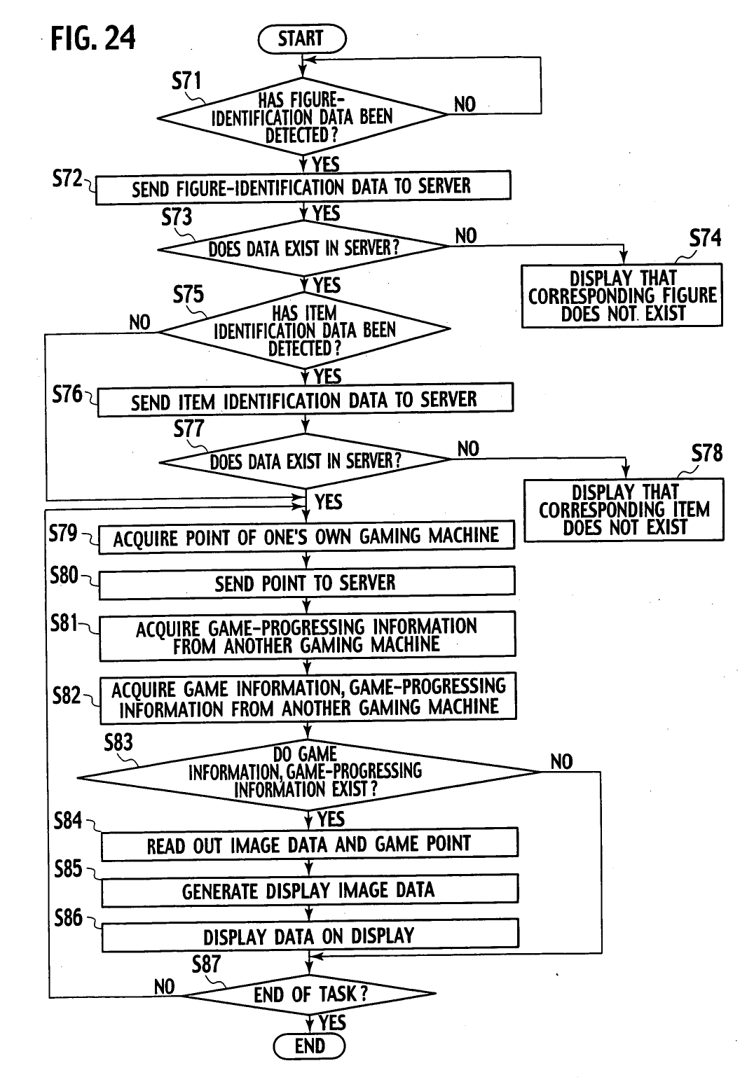

FIG. 23 is a schematic view showing a fifth embodiment, and FIG. 24 is a flow chart showing the fifth embodiment. In the fifth embodiment, figure-identification data for acquiring a FIG. 20 is acquired, and this figure-identification data is sent to the another gaming machines 1A to 1N as game-progressing information. In the case where the game-progressing information has received from a game machine 1 that is in the game-progressing mode, image data is acquired from a server 30 based on the received game-progressing information; a character or the like of the FIG. 20 is displayed on the display unit 5c by using the acquired image data; and the fact that the another gaming machines 1A to 1N that are in the game-progressing mode exists is displayed.

The fifth embodiment is substantially identical to the fourth embodiment except that the server 30 has the image data for displaying the character of the FIG. 20. Hereinafter, constituent elements different from those according to the fourth embodiment will be described, and common constituent elements are briefly described.

The gaming machine 1 includes constituent elements for displaying that the another gaming machines 1A to 1N that are in the game-progressing mode exists in addition to the game device 9 which carries out a variety of gaming operations, as in the fourth embodiment. Same as the configuration of the gaming machine 1 of the fourth embodiment, the gaming machine 1 of this embodiment comprises: the detecting unit 2 which detects the FIG. 20; the game-progressing information sending unit 3 which sends the game-progressing information detected by the detecting unit 2 to the another gaming machines 1A, 1B, . . . , 1N; the game-progressing receiving unit 4 which receives the game-progressing information sent from the another gaming machines 1A, 1B, . . . , 1N; the game information sending unit 13 which sends game information such as acquired points, accumulated points, or a game result; the game information receiving unit 14 which receives the transmitted game information; the sending and receiving section 10 which carries out sending and receiving with the server 30; the display storing unit 7 which stores the image data such as the character of the FIG. 20 received from the server 30 by means of the sending and receiving section 10; and the display means 5 which carries out image display by using the image data read out from the image-data storing unit 7.

The sending and receiving section 10 sends to the server 30 the detection information detected by the detecting unit 2 as the game-progressing information. In addition, the sending and receiving section 10 sends to the server 30 the game-progressing information received by the game-progressing information receiving unit 4; the game information received by the game information receiving unit 14; and acquired points or the like from the gaming device 9, and receives the image data read out at the server side from the server 30 based on the sent data.

Same as the configuration of the second embodiment, the server 30 of this embodiment comprises the sending and receiving section 30a, the data read out unit 30b, and the image-data storing section 30c. The data read out unit 30b reads out the figure-identification data or the acquired points from the game-progressing information or the game information sent from the gaming machine 1, and reads out the image data from the image-data storing section 30c based on the read out figure-identification data or the acquired points.

With this configuration, the image data is stored in the server 30, and thus, there is no need for each the gaming machine 1 (1A to 1N) to provide the image data according to the figure-identification data or the like, respectively. This configuration facilitates maintenance or updating of the image data.

As in the fourth embodiment, the display means 5 comprises the display image data generating section 5a, the display controller 5b, and the display unit Sc. The detecting unit 2 detects the FIG. 20 placed on the placement base.

The game-progressing information sending unit 3 sends the figure-identification data detected by the detecting unit 2 as the game-progressing information to the another gaming machines 1A to 1N via a network (not shown). The another gaming machines 1A to 1N receive the game-progressing information (figure-identification data) sent from the game-progressing information sending unit 3.

In addition, the game information sending unit 13 sends to the another gaming machines 1A to 1N via a network (not shown) the acquired points, the accumulated game points, or a game result acquired from the gaming device 9 as the game information. The another gaming machines 1A to 1N receive the game information sent from the game information sending unit 13.

In addition, the game-progressing information receiving unit 4 receives the game-progressing information (figure-identification data) sent from the another gaming machines 1A to 1N via the network. The game information receiving unit 14 receives the game information sent from the another gaming machines 1A to 1N via the network.

The sending and receiving section 10 sends to the server 30 the game-processing information or the game information the gaming machine 1 and the game-progressing information of the another gaming machines 1A to 1N received by the game-progressing information receiving unit 4 or the game information received by the game information receiving unit 14.

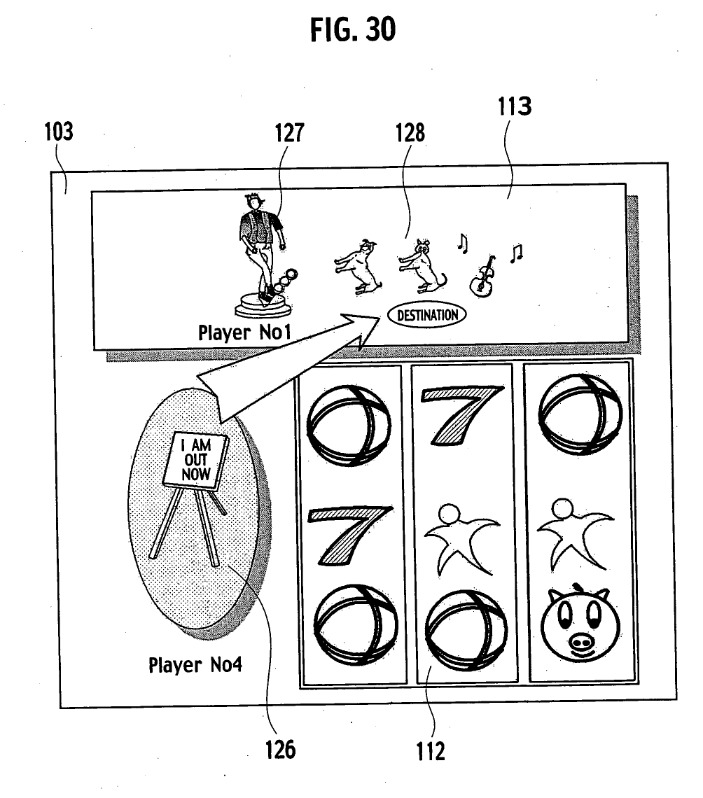

The server 30 receives at the sending and receiving section 30a the game-progressing information sent from the sending and receiving section 103. The image data read out section 30b reads out the image data of the FIG. 30 from the image-data storing section 30c based on the received game-progressing information (figure-identification data); the point data (acquired points and accumulated points), or a game result; and sends the read out data to the sending and receiving section 10 of the gaming machine 1.

The sending and receiving section 10 of the gaming machine 1 receives the image data transmitted from the server 30; stores the received data in an image-data temporary storing unit 6a; and displays the stored data in the display unit 5c.

In the fourth embodiment shown in FIG. 21, in the game point storing unit 8, image data of the FIG. 20 is stored while shapes, colors, and textiles or the like are differentiated from each other according to the player's accumulated points or the acquired points of each game; and the corresponding image data is read out according to the accumulated points or the acquired points. However, in the fifth embodiment, this function is executed by the server 30. This configuration makes it possible to carry out a game effect for making a change according to points.

In the display means 5, the display image data generating section 5a generates display image data suitable for display on the display unit 5c by using the image data inputted from the image-data temporary storing unit 6a. The display image data generating section 5a may enhance game effect property by generating the display image data by combining another kind of data with the image data.

The display controller 5b makes control when the display image data generated at the display image data generating section 5a is displayed on the display unit 5c.

Now, an example of an operation of a configuration shown in FIG. 23 will be described with reference to FIG. 24. Here, a description will be given with respect to an example of displaying the item as well as the FIG. 20.

When the FIG. 20 is placed on the placement base 105 of the gaming machine 1, the detecting unit 2 detects the figure-identification data from the recording medium such as the IC tag 21 or the two-dimensional code 22 provided at the FIG. 20 (S71).

In order to acquire from the server 30 the image data corresponding to the detected figure-identification data, the figure-identification data is sent from the sending and receiving section 10 to the server 30 (S72). The server 30 makes a search for the corresponding image data in the image-data storing section 30c based on the sent figure-identification data. In the case where the corresponding image data is not found, it is assumed that the corresponding image data is not registered; a notification that the corresponding FIG. 20 does not exist is sent from the sending and receiving section 30a to the sending and receiving section 10 at the side of the gaming machine 1 (S73); and the sent notification is displayed on the display unit 5c (S74).

Next, the presence or absence of the item as well as the FIG. 20 is detected. The detecting unit 2 detects the item-identification data from the recording medium such as the IC tag 21 or the two-dimensional code 22 and the like provided at this item (not shown) (S75). In order to determine whether or not the image data corresponding to the detected item-identification data is provided at the side of the server 30, as is the case with the figure described previously, the item-identification data is sent to the server 30, and a search is made therefor (S76).

The server 30 makes a search for the corresponding image data in the image-data storing section 30c based on the sent item-identification data. In the case where the corresponding image data is not found, it is assumed that the corresponding image data is not registered; a notification that the corresponding item does not exist is sent from the sending and receiving section 30a to the sending and receiving section 10 of the gaming machine 1 (S77); and the sent notification is displayed on the display unit 5c (S78).

In the case where the figure-identification data and/or item-identification data has been detected, the acquired points of each game is acquired from the gaming device 9, and the accumulated points are acquired from the game point storing unit (not shown) (S79).

The sending and receiving section 10 of the gaming machine 1 sends the points (acquired points and/or accumulated points of each game) to the server 30 (S80) and receives from the server 30 the transmitted figure-identification data or the item-identification data point and the image data corresponding to the points (S81).

The sending and receiving section 10 acquires from the server 30 the image data corresponding to game-progressing information and the game information (S83, S84) and stores the acquired data in the image-data temporary storing unit 6a.

In the case where the game-progressing information receiving unit 4 acquires game-progressing information or game information from the another gaming machine, the sending and receiving section 10 sends to the server 30 the game-progressing information or game information (S82).

The display image data generating section 5a generates image data display image data for displaying a figure or an item of one's own gaming machine and a figure or an item of the another gaming machine by using the image data read out from image-data temporary storing unit 6a (S85). The display unit 5c displays the generated display image data under the control of the display controller 5b (S86).

In the case where the another gaming machines 1A to 1N that are in game-progressing mode ends a game or in the case where the another gaming machines 1A to 1N that are not in the game-progressing mode starts a game midway, the steps S79 to S86 are repeated, thereby displaying a change of a game-progressing state of the another gaming machine (S87).

### Sixth Embodiment

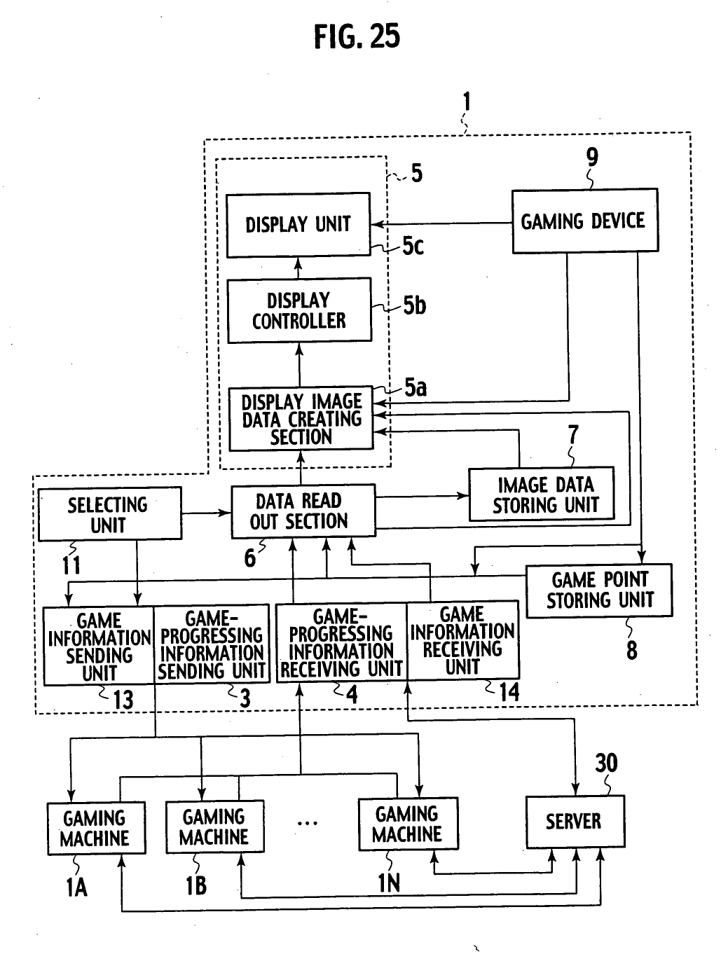

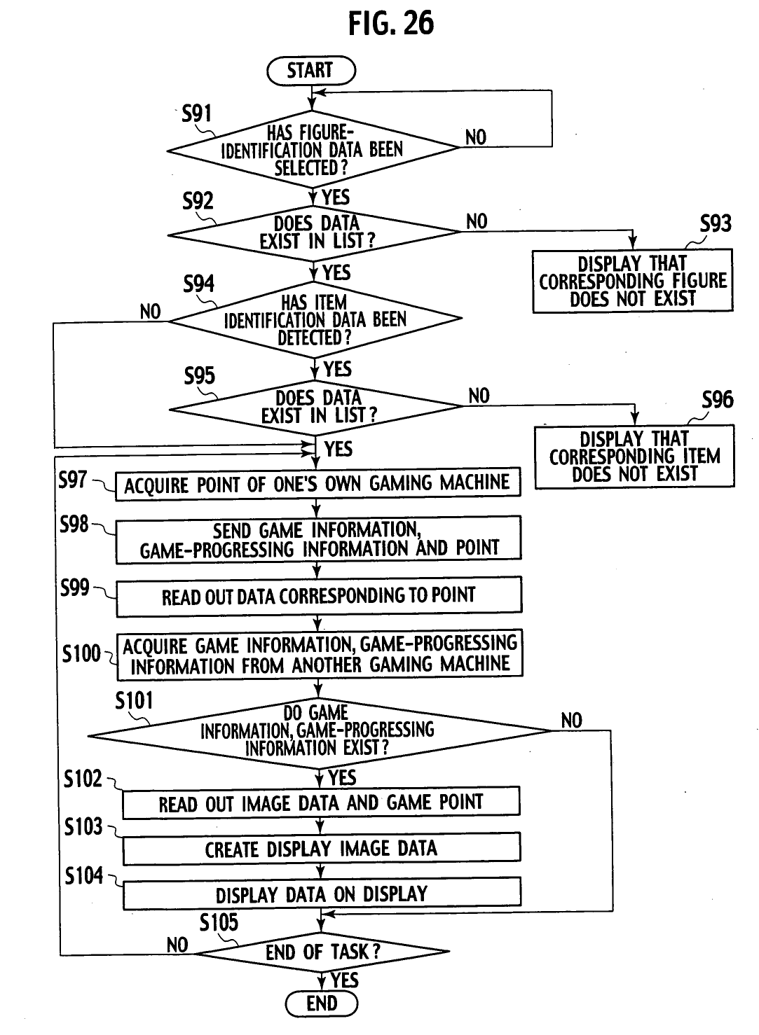

FIG. 25 is a schematic view showing a sixth embodiment, and FIG. 26 is a flow chart showing the sixth embodiment. In the sixth embodiment, figure-identification data for identifying the FIG. 20 is acquired by the selecting unit 11. Then, as in the foregoing fourth embodiment or fifth embodiment, the figure-identification data is sent to the another gaming machines 1A to 1N as the game-progressing information. In the case where the game-processing information has been received from the another gaming machines 1A to 1N that are in the game-progressing mode, the character or the like of the FIG. 20 is displayed on the display means 5 based on the received game-progressing information, and the fact that the another gaming machines 1A to 1N that are in the game-progressing mode exists is displayed.

The sixth embodiment is substantially identical to the fourth and fifth embodiments except that acquisition of figure-identification data is carried out by a selecting unit 11 such as selecting button. With respect to a configuration shown in FIG. 25, as in the fourth embodiment shown in FIG. 21, a description will be given with respect to an example of a configuration comprising image data in a gaming machine 1. A common configuration will be briefly described below.

A gaming machine 1 of this embodiment comprises the selecting unit 11 which selects the FIG. 20 as a constituent element for displaying that the another gaming machines 1A to 1N that are in the game-progressing mode exists in addition to the gaming device 9 which carries out a variety of gaming operations. The selecting unit 11 can be composed of selecting buttons or the like, outputting the figure-identification data which corresponds to the FIG. 20 selected by selecting the selecting buttons.

Apart from the selecting unit 11, as in the fourth and fifth embodiments, the gaming machine 1 comprises: the game-progressing information sending unit 3 which sends the game-progressing information such as the figure-identification data selected by the selecting unit 11 to the another gaming machines 1A to 1N and/or the server 30; the game-progressing information receiving unit 4 which receives the game-progressing information sent from the another gaming machines 1A to 1N and/or the server 30; the game information sending unit 13 which sends the game information such as the acquired points and the accumulated points or a game result; the game information receiving unit 14 which receives the sent game information; the data read out unit 6 which reads out the figure-identification data from detection information selected by the selecting unit 11 and/or the game-progressing information received by the receiving unit 4 and reads out the game information from a receiving signal of the game information receiving unit 14; the image-data storing unit 7 for storing the image data such as the character of the FIG. 20; the display means 5 which displays the image by using the image data read out from the image-data storing unit 7; and the game point storing unit 8 which stores the game points such as the accumulated bonus acquired by the gaming device 9. Each of the above-described constituent elements may have the same function of the elements of the fourth embodiment or the fifth embodiment.

Now, an example of an operation of a configuration shown in FIG. 25 will be described with reference to a flow chart shown in FIG. 26. Here, a description will be given for an example of displaying an image with respect to the item in addition to the FIG. 20.

A player detects the FIG. 20 by selecting the selecting button (S91). In order to determine whether or not the image data corresponding figure-identification data is stored in the image-data storing unit 7, for example, a search is made for list data of the figure-identification data (S92). In the case where the figure-identification data is not found in the list data, it is assumed that the corresponding image data is not recorded, and the fact that the corresponding figure does not exist is displayed on the display unit 5c (S93).

The presence or absence of the item is detected in addition to the FIG. 20. Item-identification data is detected by selecting the item using the selecting unit 11 (S94). In order to determine whether or not the image data corresponding to the detected item-identification data is stored in the image-data storing unit 7, for example, a search is made for list data of the item-identification data (S95). In the case where the item-identification data is not found in the list data, it is assumed that the corresponding image data is not registered, and the fact that the corresponding item does not exist is displayed on the display unit 5c (S96).

In the case where the figure-identification data and/or the item-identification data have(has) been detected, the acquired points of each game is acquired from the gaming device 9 and the accumulated points are acquired from the game point storing unit 8 (S97).

The game-progressing information sending unit 3 sends the acquired figure-identification data or item-identification data to the another gaming machines 1A to 1N and/or the server 30. In addition, the game information receiving unit 13 sends the game information such as the acquired points, the accumulated points, or the game result (S98).

The image-data storing unit 7 reads out image the data corresponding to the acquired figure-identification data, the item-identification data, the acquired points, the accumulated points or the game result. The image-data storing unit 7 stores the image data of the character of the FIG. 20 which corresponds to the figure-identification data or the image data of the item which corresponds to the item-identification data.

Further, in the case where an effect for changing a display state of the FIG. 20 and/or the item is carried out according to the acquired points, the accumulated points, or the game result, the image data corresponding thereto is stored, and the image data corresponding to the figure-identification data, the item-identification data, the acquired points, accumulated points, and the game result or the like is read out. This image data relates to the FIG. 20 or the item placed on one's own gaming machine 1 (S99).

The game-progressing information receiving unit 4 receives the game-progressing information of the another gaming machines 1A to 1N (S100). In the case where the figure-identification data and/or the item-identification data is included in the game-progressing information, the figure-identification data and/or the item-identification data is read out (S101), and the image data of the FIG. 20 or the item relating to the corresponding other gaming machines 1A to 1N is read out from the image-data storing unit 7 (S102).

In addition, the game information receiving unit 14 receives the game information such as the acquired points, the accumulated points, or the game result (S100). In the case where the acquired points, the accumulated points, and the game result or the like are included in the game information, these points values or the game result are read out (S101), and the corresponding image data is read out from the image-data storing unit 7 (S102).

The display image data generating section 5a generates display image data for displaying the FIG. 20 and/or the item of the gaming machine 1 read out from the image-data storing unit 7 or the FIG. 20 and/or the item of the another gaming machines 1A to 1N. At this time, display image data generating section 5a generates the display image data according to the point values or the game result of the another gaming machines 1A to 1N and the display image data for displaying the point values themselves (S103). The display unit 5c displays the generated display image data under the control of the display controller 5b (S104).

In the case where the another gaming machines 1A to 1N that are in game-progressing mode ends a game or in the case where the another gaming machines 1A to 1N that are not in the game-progressing mode starts a game midway, the steps S97 to S104 are repeated, thereby a game-progressing state of the another gaming machines 1A to 1N is re-displayed (S105).

The appearance and configuration of the game machine 1 according to each of the fourth to sixth embodiments are identical to those of the first embodiment. Therefore, a description is omitted here (with reference to FIG. 7 and FIG. 8).

Now, a display example of the gaming machine 1 according to each of the fourth to sixth embodiments will be described here. In the case where constituent elements are identical to those according to the first to third embodiments, these constituent elements are not shown here.

In the fourth to sixth embodiments, as in the first embodiment, when the FIG. 20 is placed on the placement base 105 of the gaming machine 1, the reading unit 106 reads the figure-identification data from the recording medium provided at the FIG. 20. At this time, the display screen is identical to those according to the first embodiment (with reference to FIG. 9).

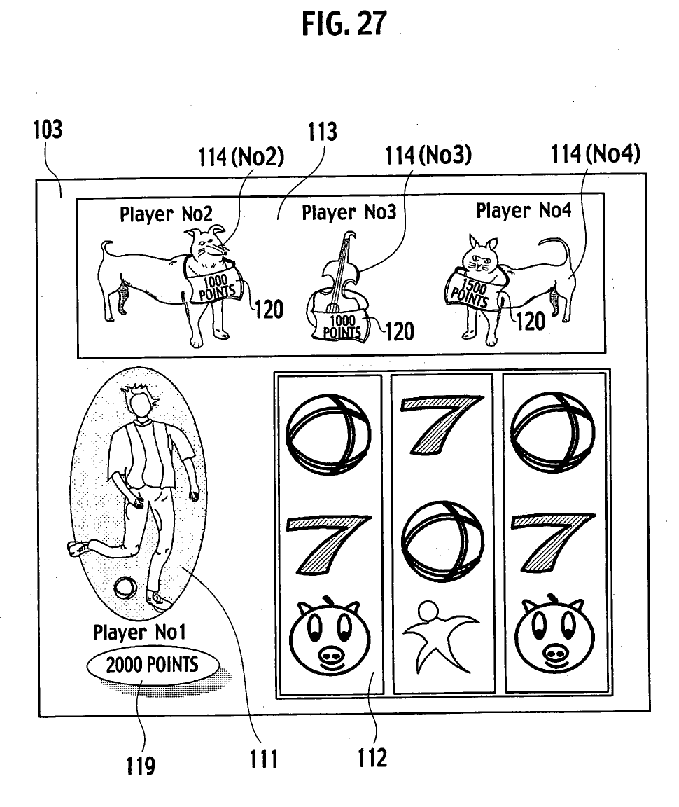

FIG. 27 shows a display example of the main display 103 in accordance with the fourth to sixth embodiments. This display is schematically identical to those according to the first to third embodiments except that points are displayed on the character images 111 (114).

In detail, a point display 119 that displays the accumulated points and the acquired points or the like acquired for each game is displayed in the vicinity of the character image 111 according to the gaming machine 1. In addition, a point display 120 that displays the accumulated points and the acquired points or the like of the another gaming machines 1A to 1N is displayed in the vicinity of the character image 114 according to the another gaming machines 1A to 1N.

The player No. 1 playing a game at the gaming machine 1 plays the game by seeing the game display 112 displayed on the main display 103 and displays the character image 111 of the FIG. 20 of the player No. 1, thereby making it possible to enhance game effect property and making it possible to check the accumulated points which have been accumulated up to now or the acquired points acquired by each game by means of the point display 119.

In addition, the character image 114 of the FIG. 20 of the another gaming machines 1A to 1N that are in the game-progressing are displayed in the game-progressing information display region 113, thereby making it possible to recognize the number of the competitor playing the another gaming machines 1A to 1N at the same time and making it possible to speculate the competitor from the character image 114 of the FIG. 20. Furthermore, it is possible to check the accumulated points of the competitors or the acquired points of the competitors by means of the point display 120.

Now, a description will be given with respect to display screens of the another gaming machines 1A to 1N of competitors. The screens displayed when other players each have placed the FIG. 20 are identical to those according to the first embodiment (with reference to FIG. 11).

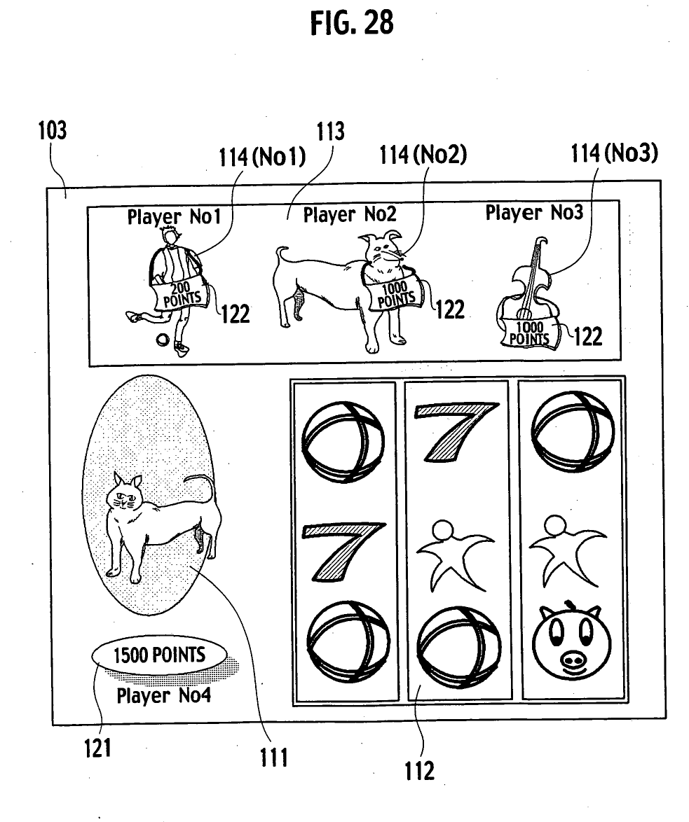

FIG. 28 shows a display example of the main display 103 in accordance with each of the fourth to sixth embodiments. This display is substantially identical to those according to the first to third embodiments (with reference to FIG. 12) except that points are displayed on character images 111 (114).

In detail, as the character image 111, there is displayed a character of the FIG. 20 placed by player No. 4 playing a game with one of the another gaming machines 1A to 1N. Further, the game-progressing information display region 113 displays the character image 114 of the FIG. 20 of the players No. 1 to No. 3.

In addition, a point display 121 which displays the accumulated points and the acquired points or the like of the player No. 4 can be displayed in the vicinity of the character image 111. In addition, a point display 122 which displays the accumulated points and the acquired points or the like of the competitors (that is the player No. 1 to No. 3 in this FIG. 289 can be displayed in the vicinity of the character image 114.

By such configuration, the player No. 4 plays the game by seeing the game display 112 displayed on the main display 103, and since the character image 111 of the player No. 4 is displayed, it is possible to enhance the game effect property, and it is also possible to check the own present accumulated points or the acquired points acquired by each game by seeing the point display 121.

In addition, the character image 114 of the FIG. 20 of the competitors are displayed on the game-progressing information display region 113, thereby making it possible to recognize the number of the competitors who plays the same game at the same time, and it is possible to speculate the competitor from the character image 114 of the FIG. 20, and it is also possible to check the competitor's accumulated points or the acquired points acquired by each game by seeing the point display 122.

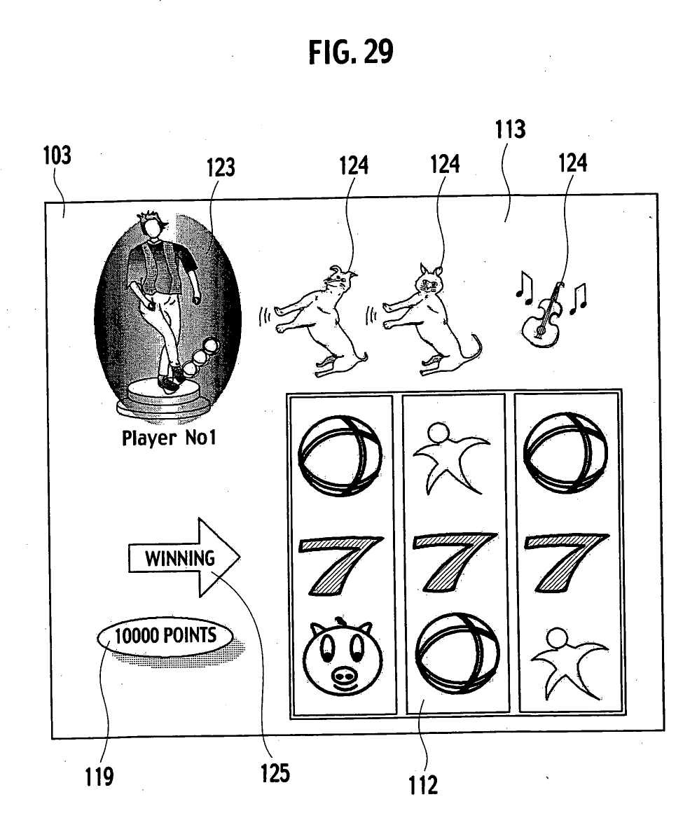

Referring to FIG. 29 and FIG. 30, a description will now be given with respect to an example of changing a display image of the gaming machine 1 according to the game state of the gaming machine 1 and an example of changing a display image of the another gaming machines 1A to 1N according to the its game state, respectively.

In FIG. 29, when a winning-combination is established at the gaming machine 1, the winning-combination is displayed on the game display 112. This winning-combination may be displayed on an area of the display region 113 with a predetermined image data (such as an arrow 125 in FIG. 29) other than the game display 112. In addition, at this time, the acquired points can be displayed on the point display 119.

In this embodiment, with respect to a character image 123 of the gaming machine 1, this character image 123 is changed according to the winning-combination. In addition, with respect to a character image 124 of the another gaming machines 1A to 1N, this character image 124 is changed according to the winning-combination.

For example, in FIG. 29, the competitor's character image 124 is changed to another character image to celebrate the player No. 1 who established the winning-combination. Of course, the variation of changing the character image based on the winning-combination is not limited to the above example.

FIG. 30 shows a display state at the another gaming machines 1A to 1N at the time of the player No. 1 established the winning-combination shown in FIG. 29. In this display example, instead of displaying a character image of the player No. 4, a display image 126 indicating that “the player is out now” is displayed. The game-progressing information display region 113 displays: a character image 127 of the player who established the winning-combination (in this example: player No. 1); and a character image 128 of the other players. This region 113 also displays a character image according to the gaming machine as a destination to which the player has gone.

Although, FIG. 30 shows an effect of image display in the another gaming machine when a winning-combination has been established, an effect image is not limited to such example.

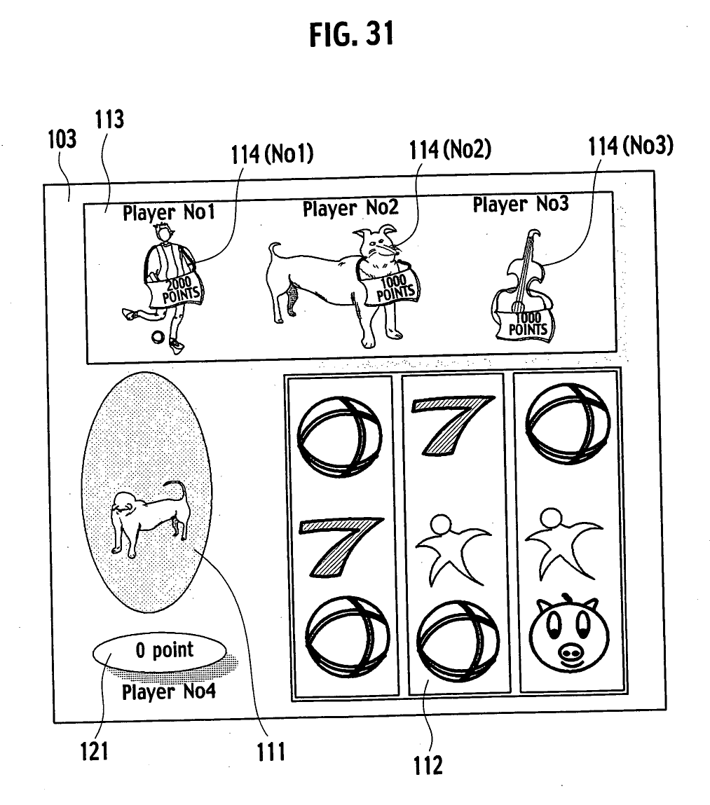

In addition, referring to FIG. 31, a description will be given with respect to another example of a display image for changing a display image according to the game state. FIG. 31 shows an example of a display image in each of the another gaming machines 1A to 1N. This display image example shows a case in which a winning-combination has not successfully established. Here, for example, the point display 121 of point “0” is displayed, and the character image 111 according to a game result is displayed.

In the fourth to sixth embodiments as well, the FIG. 20 is detected by means of the selecting button 115 so as to display the character image (with reference to FIG. 13 and FIG. 14). The characteristics are identical to those according to the above third embodiment. A duplicate description is omitted here.

In addition, in the fourth to sixth embodiments as well, a data structure identical to that according to each of the first to third embodiments can be provided (with reference to FIG. 20). Further, the disposition of gaming machines can be adopted in the same manner as that described in FIG. 17 to FIG. 19C.

The gaming machines according to the fourth to sixth embodiments can be applied to any types of gaming machines such as a vertical pinball machine, a pachinko gaming machine, a slot machine, a game device and the like as in the first to third embodiments.

According to the above-described fourth to sixth embodiments, it is possible to check a game state of a player playing a game at the another gaming machine while playing a game at the player's gaming machine.

In addition, according to the fourth to sixth embodiments, a detected figure can be used as an indicator for indicating game-progressing information. Further, game states such as points or a game result such as acquired bonus in other gaming machines are displayed and a display state of a figure is changed according to these game states, thereby making it possible to enhance game property.

What is claimed is:

1. A gaming machine connected to a network, comprising:
a detecting device which detects a figure indicating a player of the gaming machine;
a game-progressing information sending device which sends game-progressing information indicating that the gaming machine is in a game-progressing mode based on detection information outputted from the detecting device to a device including an another gaming machine and a server;
a game-progressing information receiving device which receives the game-progressing information sent from the device; and
a display device which displays an image indicating the another gaming machine is in the game-progressing mode, based on the received game-progressing information of the another gaming machine.

2. The gaming machine according to claim 1, wherein the display device displays an image indicating that the gaming machine is in the game-progressing mode based on the detection information outputted from the detecting device of the gaming machine.

3. The gaming machine according to claim 1, wherein the detecting device is comprised of an identification code detecting device which detects a figure identification code provided with the figure.

4. The gaming machine according to claim 1, further comprising:
a placement base for placing the figure, wherein the detecting device detects the figure placed on the placement base.

5. The gaming machine according to claim 1, wherein the detecting device has a detecting surface on which a placing portion for placing the figure is provided.

6. The gaming machine according to claim 3, wherein the figure identification code is provided at a tag provided with the figure, and the identification code detecting device reads the figure identification code assigned to the tag in a wireless manner.

7. The gaming machine according to claim 3, wherein the figure identification code is coded as two-dimensional information, and the identification code detecting device optically reads the figure identification code being coded as the two-dimensional information.

8. The gaming machine according to claim 1, wherein the detecting device functions as a selecting device which selects the figure, and detects the figure identification code of the figure selected by the selecting device.

9. The gaming machine according to claim 1, the gaming machine further includes image data of the figures, wherein the display device reads out the image data which corresponds to the received game-progressing information from among the image data of the figures by using the detection information detected by the gaming machine and/or the game-progressing information received by the game-progressing information receiving device; generates display image data by using the read out image data; and displays the image data of the figure detected by the gaming machine and/or the figure detected to the another gaming machine.

10. The gaming machine according to claim 1, the gaming machine receives corresponding image data from a plurality of image data of the figures which are stored in the server, by using the detection information detected by the gaming machine and/or the game-progressing information received by the game-progressing information receiving device,
wherein the display device generates display image data by using the image data received from the server, and displays the image data on the figure detected by the gaming machine and/or the figure detected by the another gaming machine.

11. The gaming machine according to claim 4, wherein the detecting device detects the plurality of figures placed on the placement base simultaneously or individually and reads out image data which corresponds to the figure from among items of image data which the gaming machine or the server stores based on the detected detection information;
and wherein the display device generates display image data by using the read out image data and displays a plurality of figures placed on the placement base.

12. The gaming machine according to claim 9, wherein the image data includes plural types of shape data for defining a shape of the figure and display state data for defining a display state of each section which configures the figure, respectively;
and wherein the display device receives a game state of the gaming machine, reads out the plural types of the shape data and/or the display state data according to the game state, generates the display image data by using the read out image data, and displays the image data of the figure according to the game state.

13. The gaming machine according to claim 12, wherein the game state is the number of points acquired in game-progressing; wherein the shape data and the display state data are stored to be associated with the number of points; and wherein the display device reads the shape data and/or display state data according to the number of points in game-progressing, generates the display image data by using the read out image data, and displays the image data on the figure according to the number of points.

14. The gaming machine according to claim 1, further comprising:
a game information sending device which sends game information indicating a game state of the gaming machine to the device; and
a game information receiving device which receives game information indicating a game state relating to the another gaming machine, the game information being sent from the device,
wherein the display device displays an image indicating that the another gaming machine is in game-progressing based on the received game-progressing information on the another gaming machine and displays a game state of the another gaming machine in game-progressing based on the received game information on the another gaming machine, and/or changes an image indicating that the another gaming machine is in game-progressing.

15. The gaming machine according to claim 14, wherein the display device generates an image indicating that the another gaming machine is in the game-progressing mode based on the figure detected by the detecting device of the another gaming machine.

16. The gaming machine according to claim 14, wherein the display device displays an image indicating that the gaming machine is in the game-progressing mode based on detection information on the detecting device of the gaming machine.

17. The gaming machine according to claim 16, wherein the display device generates an image indicating that the gaming machine is in the game-progressing mode based on the figure detected by the detecting device.

18. The gaming machine according to claim 14, wherein the game information includes at least any one of accumulated points maintained by the gaming machine, acquired points acquired by the gaming machine for each game; and a result of each game in the gaming machine.

19. The gaming machine according to claim 18, wherein the display device displays at least any one of game states from among accumulated points of the another gaming machine, acquired points of each game, and a result of each game, based on the game information and/or changes an image indicating that the another gaming machine is in game-progressing.

20. The gaming machine according to claim 19, wherein the display device changes, based on the game information, an image generated based on the figure detected by a detecting device of the another gaming machine.

21. The gaming machine according to claim 18, wherein the display device changes, based on a game result of the another gaming machine, an image generated based on the figure detected by the detecting device of the gaming machine.

22. The gaming machine according to claim 14, wherein the each gaming machine further includes a storing device for storing image data for generating an image which indicates that the gaming machine and/or the another gaming machine is in the game-progressing mode.

23. The gaming machine according to claim 15, wherein the image data for generating an image indicating that the gaming machine is in the game-progressing mode is stored in a storing device of the server.
